(19) United States
(12) Patent Application Publication
(10) Pub. No.: US 2018/0192621 A1
(43) Pub. Date: Jul. 12, 2018

(54) HABITAT CONNECTIVITY AND CONTROL

(71) Applicant: Spectrum Brands, Inc., Middleton, WI (US)

(72) Inventors: Gregory Todd VALATKA, Blacksburg, VA (US); Sean Patrick RAINES, Christiansburg, VA (US); Daniel Anderson NEWMAN, Salem, VA (US); Kevin Dean THROCKMORTON, Union, WV (US); John Edward FOX, Jr., Blacksburg, VA (US); Steven Paul SCHENDEL, Christiansburg, VA (US); Colin Adrian GRANT, Blacksburg, VA (US)

(73) Assignee: Spectrum Brands, Inc., Middleton, WI (US)

(21) Appl. No.: 15/746,373

(22) PCT Filed: Jul. 20, 2016
(86) PCT No.: PCT/US2016/043120

§ 371 Date: Jan. 19, 2018

Related U.S. Application Data
(60) Provisional application No. 62/362,310, filed on Jul. 14, 2016.
(60) Provisional application No. 62/194,673, filed on Jul. 20, 2015.

(51) Int. Cl. A01K 63/06; A01K 63/00; H04W 4/30

(52) U.S. Cl. CPC A01K 63/06; A01K 63/045; H04W 4/30; A01K 63/006

(57) ABSTRACT

Systems, apparatuses, components, devices, and methods for controlling a habitat are provided. An example habitat control system includes a habitat functional device and a habitat control hub. The habitat functional device is configured to perform a function within a habitat. The habitat control hub is configured to provide power to the habitat functional device and to transmit instructions to the habitat functional device. An example method of controlling a habitat functional device includes transmitting an information request to a habitat control hub from a user computing device. The example method further includes receiving, from the habitat control hub, a list of habitat functional devices connected to the habitat device. The example method further includes transmitting an instruction for a habitat functional device from the list of habitat functional devices to the habitat control hub.

This application is being filed on 20 Jul. 2016, as a PCT International patent application, and claims priority to U.S. Provisional Patent Application No. 62/194,673, filed Jul. 20, 2015, and to U.S. Provisional Patent Application No. 62/362,310, filed Jul. 14, 2016, the disclosures of which are hereby incorporated by reference herein in their entirety.

### BACKGROUND

Maintaining a habitat for animals or plants can be an enjoyable hobby. The habitat can include one or more of an aquatic environment or other types of environment. The habitat can be maintained in an open structure such as a pond or a structure that is enclosed or partially enclosed. The habitat may include a vivarium or cage. A vivarium is an area that is typically at least partially enclosed and is used for keeping or raising life forms such as animals and plants. Non-limiting examples of vivariums include aquariums, insectariums, and terrariums.

Fishkeeping and aquascaping are examples of hobbies that relate to maintaining various aquatic life forms in an aquatic habitat such as a pond or aquarium. Fishkeeping involves the keeping of fish in an aquatic habitat, while aquascaping involves arranging and maintaining aquatic plants and other decorative elements within aquatic habitats. Fishkeeping and aquascaping may be performed independently or together in the same aquatic habitat.

Maintaining an aesthetically pleasing habitat in which fish, plants, and other living things can survive may present various complexities and difficulties. For example, multiple factors, including lighting, temperature, and water quality, all affect the suitability of an aquarium or pond for supporting life. Additionally, many of these same factors and others may affect the aesthetics of an aquarium or pond. Other types of habitats are also affected by similar factors.

### SUMMARY

In general terms, this disclosure is directed to a system for habitat control. In one possible configuration and by non-limiting example, the system includes a habitat control hub that provides power and control signals to at least one habitat functional device. Various aspects are described in this disclosure, which include, but are not limited to, the following aspects.

In an aspect, a habitat control system comprising: a habitat functional device configured to perform a function within a habitat, wherein the habitat functional device stores identification data; and a habitat control hub configured to provide power to the habitat functional device and to transmit instructions to the habitat functional device.

In another aspect, a habitat control hub comprising: a connectivity port configured to connect to a habitat functional device; a network interface device configured to communicate over a network; a power delivery device configured to transmit power to the habitat functional device via the connectivity port; and a control unit.

In yet another aspect, a habitat functional device, comprising: a function performing device configured to perform a function within a habitat; a power receiving device configured to receive power from a habitat control hub; an identification engine configured to transmit identification information to the habitat control hub; and a habitat interface engine configured to receive instructions from the habitat control hub.

In another aspect, a method for controlling a habitat functional device, the method comprising: transmitting, from a user computing device, account identification information associated with a user account to a server computing device; receiving, from the server computing device, information about a habitat device associated with the user account, wherein the information includes a list of habitat functional devices associated with the habitat device; and transmitting an instruction for a habitat functional device from the list of habitat functional devices to the server computing device.

In yet another aspect, a method for controlling a habitat functional device, the method comprising: transmitting an information request to a habitat control hub from a user computing device; receiving, from the habitat control hub, a list of habitat functional devices connected to the habitat device; and transmitting to the habitat control hub an instruction for a habitat functional device from the list of habitat functional devices.

In another aspect, an aquarium connectivity system, the system comprising: a habitat functional device configured to perform a function within an aquarium, wherein the habitat functional device stores identification data; and a habitat control hub configured to provide power to the habitat functional device and to transmit instructions to the habitat functional device.

In another aspect, an terrarium connectivity system, the system comprising: a habitat functional device configured to perform a function within a terrarium, wherein the habitat functional device stores identification data; and a habitat control hub configured to provide power to the habitat functional device and to transmit instructions to the habitat functional device.

In another aspect, a method of managing an environment in a habitat device, comprising: receiving, on a computing device, login information from a user; using the login information to login to a user account on a server computing device; receiving, from the server computing device, information about a habitat device associated with the user; accessing an image associated with the habitat device; evaluating an environmental property associated with the habitat device based in part on the image; and generating a recommendation based on the evaluated environmental property.

### BRIEF DESCRIPTION OF THE DRAWINGS

FIG. 1 illustrates an example system for habitat control.

FIG. 2 illustrates an embodiment of the habitat control hub of FIG. 1.

FIG. 3 illustrates a schematic block diagram of the habitat control hub of FIG. 1.

FIG. 4 is a flow chart illustrating an example method of configuring the habitat control hub of FIG. 1 to connect to a network.

FIG. 5 is a flow chart illustrating an example method of identifying a habitat functional device connected to a connection port of the habitat control hub of FIG. 1.

FIG. 6 illustrates an embodiment of a combination device that operates as both the habitat device and the habitat control hub of FIG. 1.

FIG. 7 illustrates another embodiment of a combination device that operates as both the habitat functional device and the habitat control hub of FIG. 1.

FIG. 8 illustrates a schematic block diagram of the habitat control engine.

FIG. 9 is a flow chart illustrating an example method of operating the user computing device to configure the habitat control hub of FIG. 1 to connect to a network.

FIG. 10 illustrates an example user interface screen generated by some embodiments of the user interface engine of FIG. 8 and displayed by some embodiments of the user computing device of FIG. 1.

FIGS. 11-28 show additional example user interface screens that are also generated by some embodiments of the user interface engine of FIG. 8 and displayed by some embodiments of the user computing device of FIG. 1.

FIG. 29 illustrates a schematic block diagram of the habitat interface engine of FIG. 1.

FIG. 30 illustrates a schematic block diagram of an embodiment of the habitat functional device of FIG. 1.

FIG. 31 illustrates an embodiment of a wireless communication device for use with embodiments of the habitat functional devices of FIG. 1.

FIG. 32 shows additional details of some embodiments of the wireless communication device of FIG. 31.

FIG. 33 is a block diagram illustrating example physical components of a computing device that may be used to implement various aspects of the system of FIG. 1.

FIG. 34 is another example user interface screen generated by some embodiments of the user interface engine of FIG. 8 and is displayed by some embodiments of the user computing device of FIG. 1.

FIG. 35 is an example user interface flow of some embodiments of the user computing device of FIG. 1 for controlling one or more lighting functional device.

### DETAILED DESCRIPTION

Various embodiments will be described in detail with reference to the drawings, wherein like reference numerals represent like parts and assemblies throughout the several views. Reference to various embodiments does not limit the scope of the claims attached hereto. Additionally, any examples set forth in this specification are not intended to be limiting and merely set forth some of the many possible embodiments for the appended claims.

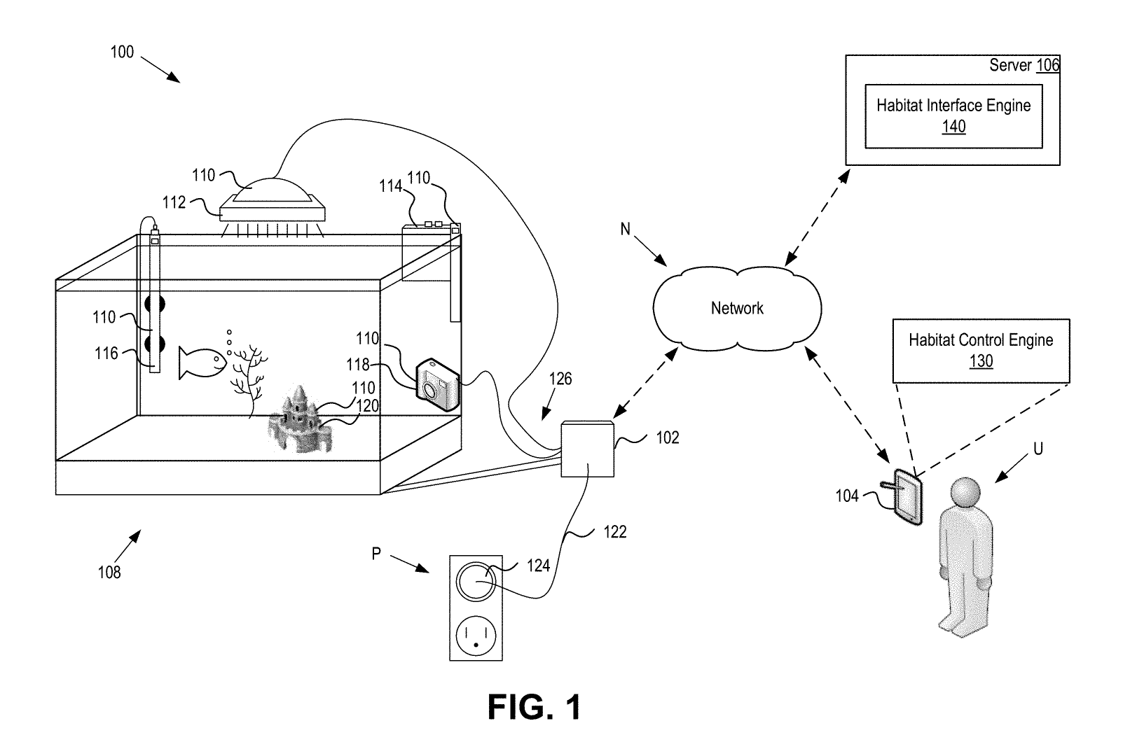

FIG. 1 illustrates an example system 100 for habitat control. The system 100 includes a habitat control hub 102, a user computing device 104, a server 106, a habitat device 108, and one or more habitat functional devices 110. The example system 100 illustrated in FIG. 1 includes a light functional device 112, a filter functional device 114, a temperature functional device 116, a camera functional device 118, and a décor functional device 120. Other embodiments include additional, fewer, or different habitat functional devices 110. Additional examples of the habitat functional devices 110 include functional devices that operate to dispensing food and devices that operate to monitor attributes of the habitat. Also shown in FIG. 1 are a network N, a power source P, and a user U.

The habitat control hub 102 operates to control or communicate with one or more of the habitat functional devices 110. Additionally, in some embodiments, the habitat control hub 102 operates to provide power to one or more of the habitat functional devices 110. In some embodiments, the habitat control hub 102 includes a power cord 122 that includes a plug 124 to connect to the power source P. The habitat control hub 102 is connected to the habitat functional devices 110 via one or more cables 126. Additionally, some embodiments of the habitat control hub 102 also operate to connect to one or more of the habitat functional devices 110 wirelessly, such as by using Wi-Fi, Bluetooth, ZigBee, Near Field Communication (NFC), or other wireless technologies. Further, in some embodiments the habitat control hub 102 interconnects with other home automation or Internet-of-Things hubs or control devices (e.g., so that the user U can control all devices from a single location, to synchronize control of the habitat functional devices 110 with control of other home devices (e.g., lights), etc.). Additionally, some embodiments of the habitat control hub 102 connect with various entertainment devices so as to coordinate the activity of the habitat functional devices 110 with the entertainment devices (e.g., to cause lights to flash in a sequence upon achievement of a goal in a game, or to dim lights based on a movie being played, etc.).

The user computing device 104 is a computing device. In some embodiments, the user computing device 104 includes a habitat control engine 130. In some embodiments, the user computing device 104 is a mobile computing device, such as a tablet computer (such as the iPad® device available from Apple, Inc., or other tablet computers running an operating system like the Microsoft Windows operating system from Microsoft Corporation of Redmond, Wash., or the Android operating system from Google Inc. of Mountain View, Calif.), a smartphone, or other mobile computing device. In some embodiments, the user computing device 104 includes a touch sensitive display for receiving input from a user either by touching (or nearly touching) with a finger or using a stylus. Some embodiments include other input devices and interfaces for receiving input from the user U as well.

In some embodiments, the user computing device 104 operates to do one or more of conveying information to the user U and receiving input from the user U. In some embodiments, the user computing device 104 operates to receive inputs from the user U that represent instructions for one or more of the habitat functional devices 110. The user computing device 104 then transmits a corresponding instruction to the habitat control hub 102 via the network N. Upon receiving the instruction, the habitat control hub 102 then transmits a corresponding instruction to the appropriate one or more of the habitat functional devices 110. Additionally, in some embodiments, the user computing device 104 operates to receive information from the habitat control hub 102 via the network N. Examples of information received from the hub includes information that identifies the habitat functional devices 110 that are connected to the habitat control hub 102, status information from or about one or more of the habitat functional devices 110, and measurements or other data captured by one or more of the habitat functional devices 110.

In some embodiments, the user computing device 104 transmits/receives communication directly to/from the habitat control hub 102 such as via a direct Bluetooth or Wi-Fi connection. Additionally or alternatively, the user computing device 104 transmits/receives communication to/from the habitat control hub 102 via one or more intermediary computing devices such as access points, switches, routers, gateways, firewalls, etc. Additionally, in some embodiments, user computing device 104 communicates with the habitat control hub 102 via the server 106.

In some embodiments, the user computing device 104 connects through a wireless network, such as a cellular telephone network. In other embodiments, the user computing device 104 connects to a local area network which may be within a structure, such as a home, office, hotel, coffee shop, or other building. In some embodiments, a connection to the local area network is made wirelessly through a wireless access point connected to the local area network. The user computing device 104 may be a mobile computing device such as a smart phone or a stationary computing device such as desktop computer.

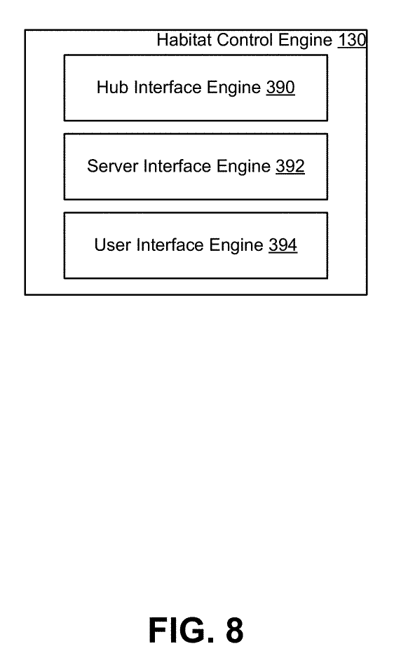

In some embodiments, the habitat control engine 130 operates to generate interfaces for presenting information to and receiving input from the user U. Additionally, in some embodiments, the habitat control engine 130 operates to communicate with a least one of the habitat control hub 102 and the server 106. Embodiments of the habitat control engine 130 are illustrated and described with respect to at least FIGS. 8-28.

Although FIG. 1 shows a single user computing device 104 and a single habitat control hub 102, other embodiments include additional computing devices and habitat control hubs, which can be located in one or more different facilities, buildings, or geographic locations. In some embodiments, multiple computing devices communicate with a single habitat control hub. Additionally, in some embodiments, a single computing device communicates with multiple habitat control hubs. Further, some embodiments do not include the habitat control hub 102. Instead, the user computing device 104, including the habitat control engine 130, provide some or all of reminder functionality, inventory management functionality, and water/environment testing functionality without interacting with a habitat control hub 102.

The server 106 comprises one or more computing devices and communicates with one or more of the habitat control hub 102 and the user computing device 104. In some embodiments, the server 106 communicates with multiple habitat control hubs and multiple computing devices. In some embodiments, the server 106 includes a habitat interface engine 140.

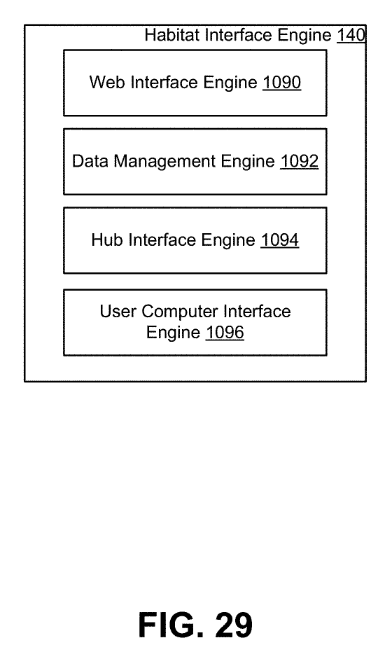

In some embodiments, the habitat interface engine 140 operates to manage information associated with the habitat control hub 102 or the habitat functional devices 110 and comprises one or more database management applications and one or more web server applications. For example, the habitat interface engine 140 operates to provision (or associate) one or more of the habitat control hub 102 and the habitat functional devices 110 with the user U (or an account associated with the user U) in some embodiments. Embodiments of the habitat control engine 130 is illustrated and described with respect to at least FIG. 29.

The habitat device 108 operates to contain and support a habitat for animal or plant life. In the embodiment shown in FIG. 1, the habitat device 108 is an aquarium. In other embodiments, the habitat device 108 is another type of vivarium. Additionally, in some embodiments, the habitat device 108 is a pond or a bowl. In various embodiments, the habitat device 108 is formed in various shapes and sizes.

The habitat functional devices 110 are devices that perform a function. In some embodiments, one or more habitat functional devices 110 operate to alter, maintain, observe, or enhance the habitat device 108 or the habitat contained therein.

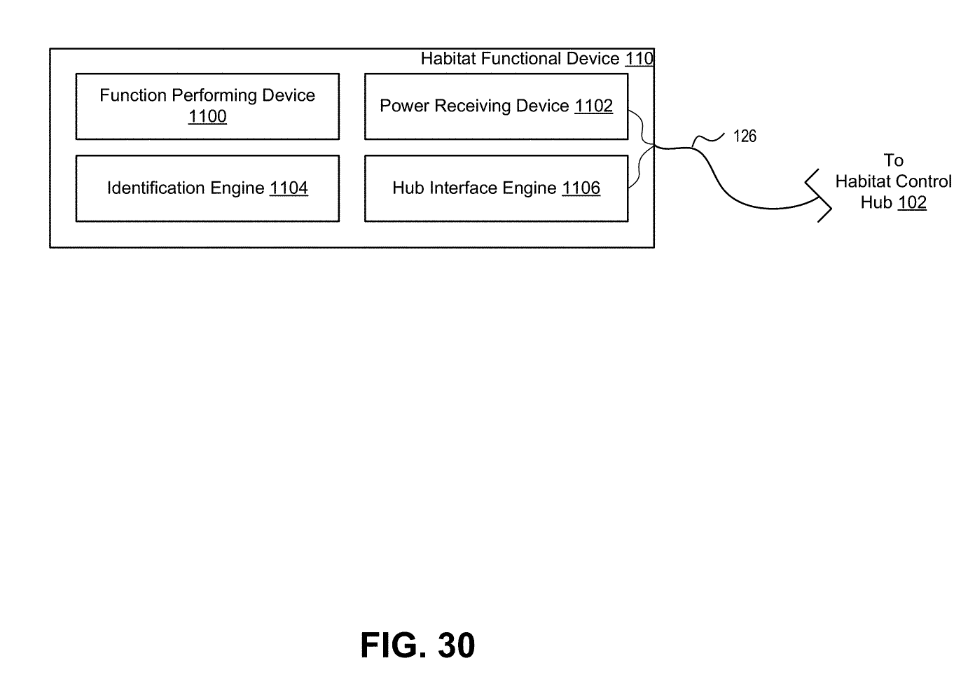

In at least some embodiments, the habitat functional devices 110 include functional units that identify the habitat functional device to the habitat control hub 102 and interact with the habitat control hub 102. In some embodiments, one or more of the habitat functional devices 110 receives power from the habitat control hub 102. Additionally or alternatively, one or more of the habitat functional devices 110 receives power via a power cord connected directly to the power source P. In other embodiments, one or more of the habitat functional devices 110 receives power from another of the habitat functional devices 110. In addition, in at least some embodiments, one or more of the habitat functional devices 110 receive operational instructions from the habitat control hub 102 such as to turn on/off, to increase/decrease operation, and to perform a specific operation or sequence of operations. The habitat functional devices 110 can also include tactile input control devices (e.g., physical buttons and knobs) that allow for independent/direct control of the habitat functional devices 110. The tactile input control devices may be disabled when the habitat functional devices 110 are connected to and controlled by the habitat control hub 102. Embodiments of the habitat functional devices 110 are illustrated and described with respect to at least FIG. 30.

The light functional device 112 is an example of the habitat functional devices 110 and operates to provide light to the habitat. In some embodiments, the light functional device 112 includes one or more light-emitting diodes (LEDs). Additionally or alternatively, some embodiments of the light functional device 112 include other light devices such as incandescent lights, florescent lights, compact florescent lights, halogen lights, neon lights, and other types of lights. In some embodiments, the light functional device 112 is can generate various colors/wavelengths and intensities of light. Furthermore, in some embodiments, the light functional device 112 is operable to generate various lighting sequences, which may include sequentially generating light in various colors/wavelengths or intensities such as to simulate the rising or setting of the sun, the passage of time during a day, or various weather effects (e.g., lightning, passing clouds, etc.). The colors/wavelengths can include visible and non-visible wavelengths of light such as colors in the visible spectrum, ultraviolet light, and infrared light.

The filter functional device 114 is another example of the habitat functional devices 110 and operates to filter a component of the habitat. For example, in an aquatic habitat, the filter functional device 114 may operate to filter water. In at least some embodiments, the filter functional device 114 includes one or more filters and one or more pumps. In some embodiments, the filter functional device 114 includes a variable-speed pump that can operate at multiple different speeds. In at least some embodiments, the filter functional device 114 includes a receiver for a filter cartridge that operates to transmit status information to the filter functional device 114 or the habitat control hub 102 such as when the filter cartridge is installed or removed and when the filter cartridge detects that it is blocked with debris or that the pump is inoperable.

The temperature functional device 116 is another example of the habitat functional devices 110 and operates to determine a temperature of a component of the habitat. In some embodiments, the temperature functional device includes a thermometer such as an underwater thermometer. Additionally, in some embodiments, the temperature functional device 116 includes an element that operates to alter the temperature of a component of the habitat such as a heater or cooling device. For example, in an aquatic habitat, the temperature functional device 116 may operate to heat water to a temperature suitable for the inhabiting plants or animals. In at least some embodiments, the temperature functional device 116 includes one or more heating elements and one or more thermostats. In some embodiments, the temperature functional device 116 includes a thermostat that can be configured to maintain a desired temperature or temperature range.

Alternatively, the temperature functional device 116 communicates with a separate heating or cooling functional device via the habitat control hub 102. For example, the temperature functional device 116 can comprise a thermometer. The temperature functional device 116 then determines a water temperature, compares the determined temperature to a target temperature, and based on that comparison transmits a signal to the habitat control hub 102 to activate or deactivate a heater device connected to the habitat control hub 102.

The camera functional device 118 is another example of the habitat functional devices 110 and operates to capture images of the habitat. In at least some embodiments, the camera functional device 118 operates to capture both still images and video images. In some embodiments, the camera functional device 118 includes motorized components that are configured to aim (pan, tilt, zoom, etc.) the camera (which may be controlled with the habitat control engine 130 via the habitat control hub 102). In some embodiments, the camera functional device 118 is configured to be disposed external to the habitat device 108. In other embodiments the camera functional device 118 is configured to be disposed in the habitat device 108 (e.g., submersed in an aquarium) and may be controllable to move around within the habitat device 108. Additionally, the camera functional device 118 may include a magnetic mounting system that allows it to be mounted on an interior surface of the habitat device 108. In some embodiments, the camera functional device 118 may capture images based upon detecting motion within the habitat device 108.

Additionally, some embodiments of the camera functional device 118 operate to detect motion outside of the habitat device 108 (such as to detect predatory or menacing animals approaching the habitat device 108). Further, in some embodiments, upon detecting an animal approaching that may be a threat to the habitat device 108 the habitat control hub 102 may take actions to scare away or otherwise neutralize the animal (e.g., spraying jets at deer or birds approaching an outdoor pond, sounding an alarm, or playing distracting light patterns to entertain a cat, etc.). In other embodiments, known animals, such as pets, are detected based on RFID tags in collars. Upon detecting the presence of the RFID tag, an appropriate action can be taken (e.g., play distracting light sequences or sounds, sound alarm to scare or attract the attention of the user U, etc.).

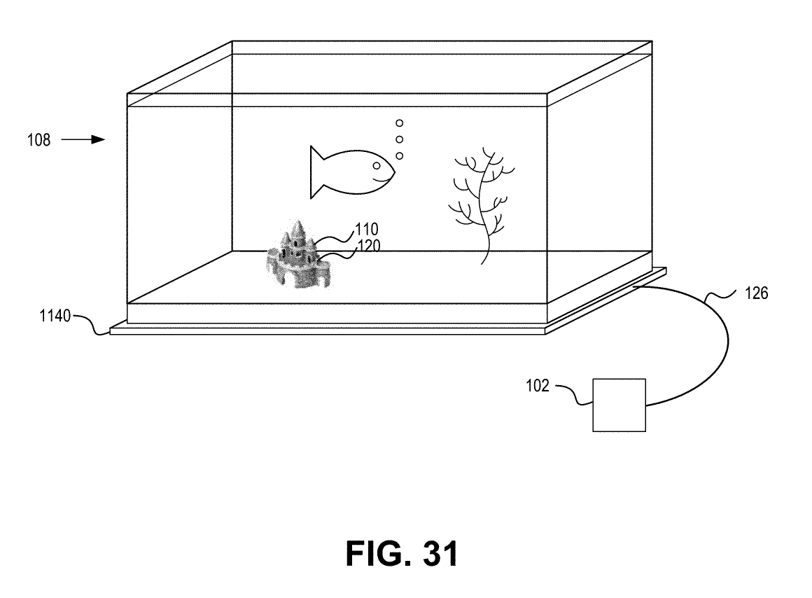

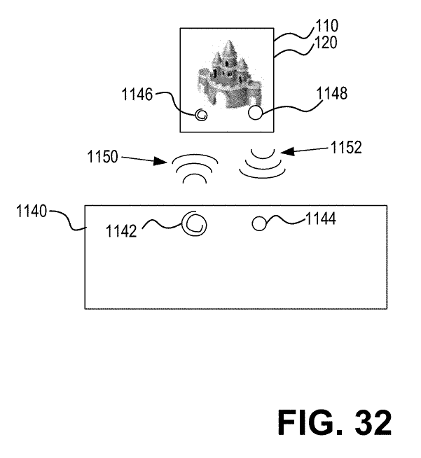

The décor functional device 120 is another example of the habitat functional devices 110 and operates to enhance the aesthetics of the habitat device 108. Various embodiments of the décor functional device 120 have various shapes, sizes, and styles. In some embodiments, the décor functional device 120 operates to emit light or bubbles or move a component thereof (e.g., opening a door or seashell). Additionally, the décor functional device 120 may include the capability to move within the aquatic habitat, which may operate automatically, in response to commands from a user via the habitat control hub 102, or both. In some embodiments, the décor functional device 120 is connected to the habitat control hub 102 via one of the cables 126. In other embodiments, the décor functional device 120 wirelessly connects to the habitat control hub 102. Wireless connections may be particularly beneficial in embodiments related to aquatic habitats. Embodiments of the décor functional device 120 are illustrated and described with respect to at least FIGS. 31-32.

Additional examples of the habitat functional devices 110 include devices that introduce chemicals or other substances into the habitat device (e.g., water quality related chemicals, etc.), devices that can add water or other substances to the habitat, and leak sensing devices to detect leaks. In some embodiments, the leak sensing device may cause the habitat control hub 102 to shut down the other habitat functional devices and, in some cases, the habitat control hub 102 to when a leak is detected. Some embodiments also include a water level sensor and when the water level is too low, the habitat control hub 102 disables or alters the operation of one or more of the other habitat functional devices 110 (e.g., disabling the heaters and pumps). Yet more examples of the habitat functional devices 110 include waterfalls, UV clarifiers, and jets (e.g., for outdoor ponds). Another example of the habitat functional devices is a scent engine that disperses a pleasant masking scent upon detection of a foul odor emanating from the habitat device 108.

In some embodiments, one or more of the habitat functional devices 110 are integrated into the habitat device 108. For example, in some embodiments the habitat device 108 is an aquarium wherein one or more walls include a display panel (such as an LCD screen) the content of which can be controlled by the user U. Although many of the examples herein show the habitat control engine 130 operating on the user computing device 104, the habitat control engine 130 can also be integrated with the habitat device 108 as well. For example, the habitat device 108 can include user input elements such as buttons or a touchscreen through which a user may control the habitat functional devices 110 without needing to use the user computing device 104.

The cables 126 each operate to form an electrical path between the habitat control hub 102 and one of the habitat functional devices 110. In some embodiments, the cables 126 are USB cables. Additionally, in some embodiments, the cables 126 operate to form a connection between two of the habitat functional devices 110 such as to form a daisy chain that ultimately connects to the habitat control hub 102. In some embodiments, the cables 126 each include two connectors that are joined by a plurality of insulated wires. For example, some embodiments of the cables 126 include four insulated wires disposed between two USB connectors. In these embodiments, each of the connectors includes at least four contacts (one for each of the insulated wires) that are configured to mate with corresponding contacts on an appropriate port. Examples of USB connectors include standard-A plugs, standard-B plugs, micro-B plugs, mini-B plugs, and standard-A receptacles. Various embodiments include various combinations of the various plugs. Additionally, other embodiments include other types of connector. Further, in some embodiments, the cable is hard wired to a particular habitat functional device and includes only a single connector (e.g., to connect to the habitat control hub 102 or otherwise). In some embodiments, at least two of the four insulated wires are arranged to form a twisted pair.

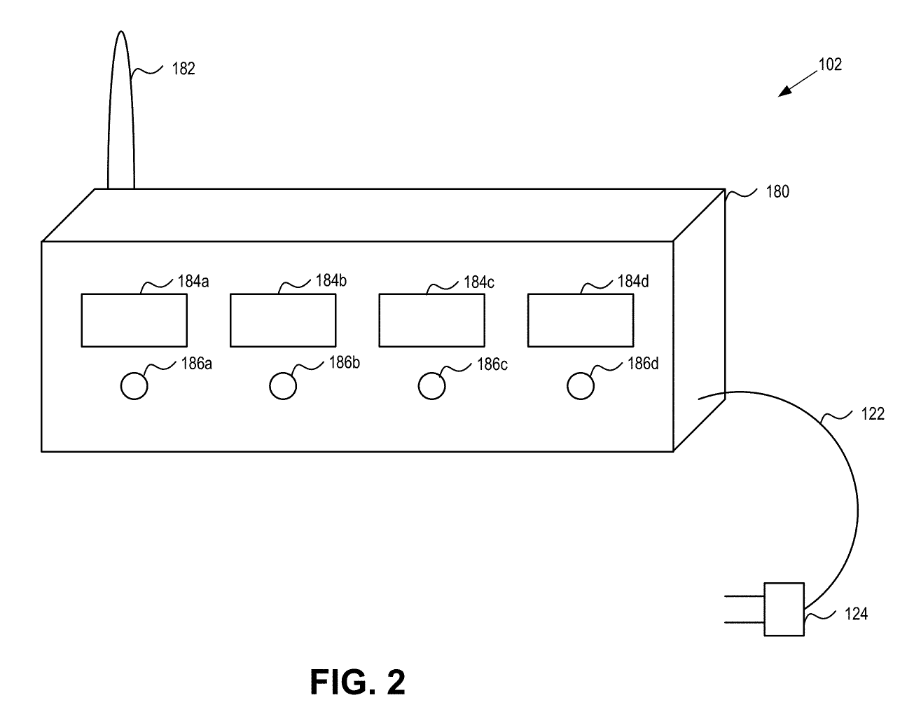

FIG. 2 illustrates an embodiment of the habitat control hub 102. In the embodiment shown, the habitat control hub 102 includes a housing 180, an antenna 182, connection ports 184a, 184b, 184c, and 184d (referred to collectively as connection ports 184), and indicators 186a, 186b, 186c, and 186d (referred to collectively as indicators 186).

The housing 180 is a structure that operates to contain internal components of the habitat control hub 102. The housing 180 may be formed from various materials including metals and plastics or combinations thereof. In some embodiments, the housing 180 is formed from multiple panels that are coupled together (e.g., with fasteners such as screws).

The antenna 182 operates to receive and transmit electromagnetic waves such as signals corresponding to wireless communication (e.g., Bluetooth, ZigBee, Wi-Fi, etc.). In some embodiments, the antenna 182 is disposed on an exterior surface of the housing 180. In other embodiments, the antenna 182 is disposed within the housing 180. In some embodiments, the antenna 182 is repositionable. In other embodiments, the antenna 182 is fixed in a static position.

The connection ports 184 operate to receive connectors from the cables 126. In the embodiment shown in FIG. 2, the habitat control hub 102 includes four connection ports. In other embodiments, however, the habitat control hub 102 includes more or fewer than four connection ports 184. In some embodiments, the connection ports 184 include a receptacle for a USB plug, such as standard-A plugs, standard-B plugs, micro-B plugs, and mini-B plugs. Other embodiments are possible as well, including embodiments that include combinations of multiple types of receptacles.

The indicators 186 operate to communicate information about connection ports 184. In some embodiments, each of the indicators 186 corresponds to and communicates information relating to one of the connection ports 184 (e.g., indicator 186a corresponds to connection port 184a, indicator 186b corresponds to connection port 184b, etc.). In some embodiments, the indicators 186 include one or more lights. In some embodiments, the indicators 186 communicate status information about corresponding connection ports, such as whether a habitat functional device is connected, whether the connected habitat functional device is drawing power, whether the connected habitat functional device is transmitting or receiving data, etc. Some embodiments include a global indicator (i.e., an indicator that is not associated with a particular one of the connection ports 184). The global indicator may operate to indicate that an error or alarm condition has occurred.

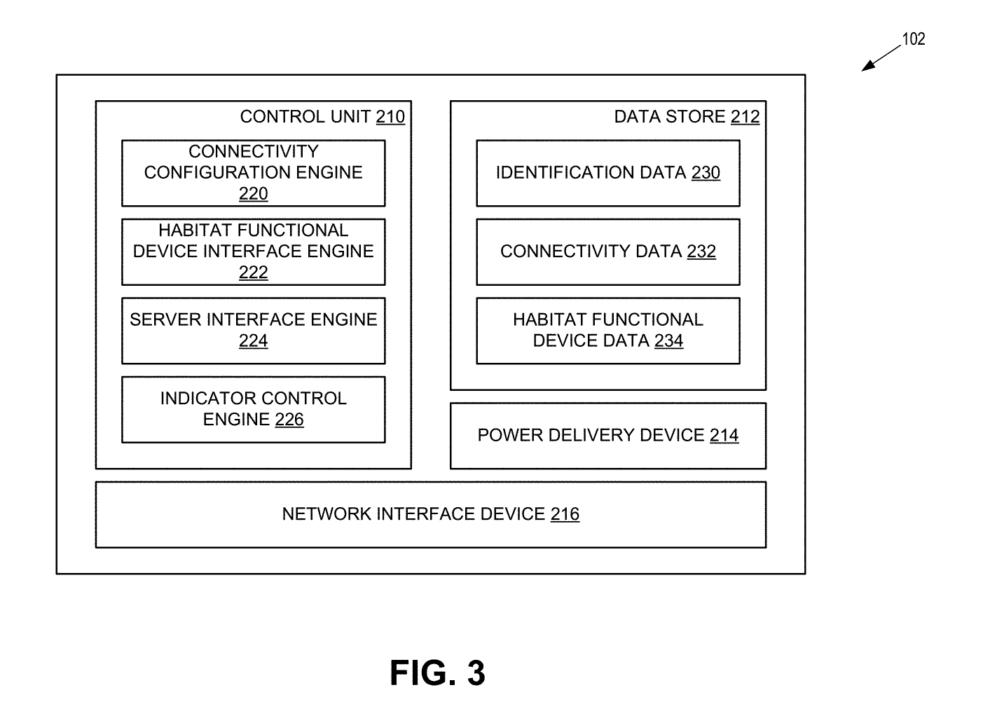

FIG. 3 illustrates a schematic block diagram of the habitat control hub 102. In some embodiments, the habitat control hub 102 includes a control unit 210, a data store 212, a power delivery device 214, and a network interface device 216. In some embodiments, the habitat control hub 102 includes one or more computing devices, and one or more of the control unit 210, the data store 212, the power delivery device 214, and the network interface device 216 are components of those one or more computing devices. In some embodiments, the habitat control hub 102 includes electronic circuits that are configured to perform at least some of the functions described herein.

In some embodiments, the control unit 210 includes a connectivity configuration engine 220, a habitat functional device interface engine 222, a server interface engine 224, and an indicator control engine 226.

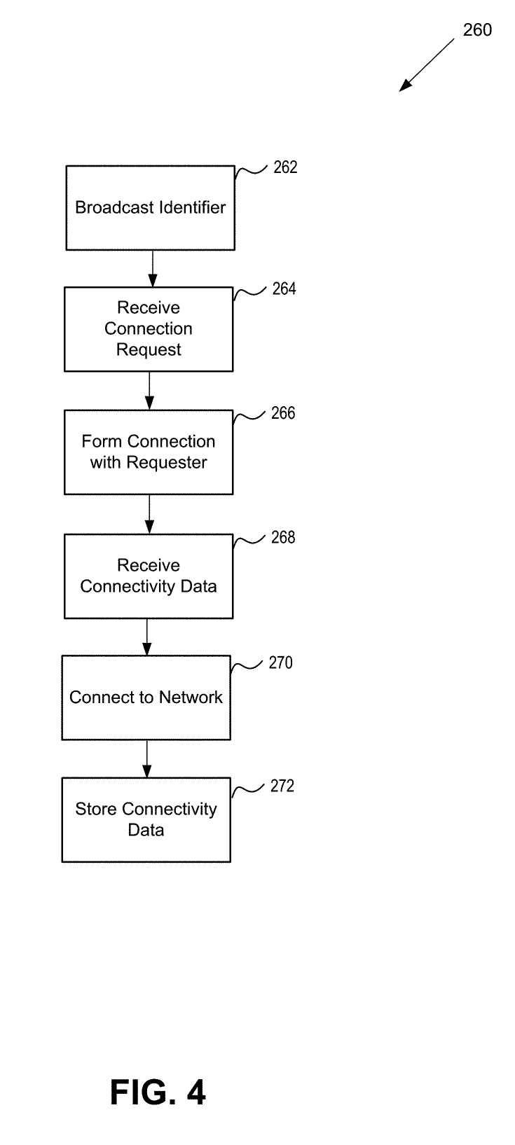

The connectivity configuration engine 220 operates to configure the habitat control hub 102 to connect to the network N. Embodiments of the connectivity configuration engine 220 are illustrated and described with respect to at least FIG. 4.

The habitat functional device interface engine 222 operates to communicate with the habitat functional devices 110. For example, the habitat functional device interface engine 222 operates to identify the habitat functional devices 110 that are connected to the habitat control hub 102 and to issue appropriate instructions to those habitat functional devices 110.

The server interface engine 224 operates to communicate with the server 106. In some embodiments, the connectivity configuration engine 220 operates to configure the habitat control hub 102 to communicate with the server 106. In some embodiments, the server interface engine 224 operates to transmit data such as status information, images, and collected data to the server 106. In some embodiments, the transmitted data relates to or is generated by one or more of the habitat functional devices 110. Additionally, in some embodiments, the transmitted data relates to or is generated by the habitat control hub 102. Further, in some embodiments, the connectivity configuration engine 220 operates to receive instructions from the user computing device 104 or the server 106. The received instructions may be directed to one or multiple of the connected habitat functional devices 110 or the received instructions may be directed to the habitat control hub 102 itself.

The indicator control engine 226 operates to control the indicators 186. In some embodiments, the indicator control engine 226 causes the indicators 186 to indicate one or more of the following: that the habitat control hub 102 has been configured; that data is being received from the server 106; that data is being received from one or more of the habitat functional devices 110; that data is being transmitted to one or more of the habitat functional devices 110; and a status of the habitat control hub 102 or one of the habitat functional devices 110.

The data store 212 operates to store data for the habitat control hub 102. In some embodiments, the data store 212 includes one or more forms of computer-readable storage media. In some embodiments, the data store 212 includes databases, files, or various data structures. In some embodiments, the data store 212 includes identification data 230, connectivity data 232, and habitat functional device data 234.

The identification data 230 operates to identify the habitat control hub 102. In some embodiments, the identification data 230 includes one or more of a model number, a serial number, a manufacturing date, and other manufacturing information. In other embodiments, the identification data 230 includes information about the user U of the habitat control hub 102, and the location of the habitat control hub 102 (e.g., the geographic location, room name, floor, etc.). Additionally, in at least some embodiments, the identification data 230 includes information about the habitat device 108 or habitat devices with which the habitat control hub 102 is associated such as the type of habitat device, and the number and types of animal or plant species contained in the habitat device 108. Rather than storing all of this information directly, in some embodiments, a reference is stored in the identification data 230 that can be used to identify an associated record that is stored by the server 106.

The connectivity data 232 comprises data that the habitat control hub 102 uses to connect to the server 106. Examples of the connectivity data 232 include an address or another identifier of the server 106 (e.g., an IP address, MAC address, domain name, etc.), connection information (e.g., protocol type, port number, etc.) and login information (e.g., a username, security key, password, etc.).

The habitat functional device data 234 comprises data about the habitat functional devices 110. In at least some embodiments, the habitat functional device data 234 comprises data about each of the connected habitat functional devices 110. For example, in some embodiments, the habitat functional device data 234 includes identification information for the habitat functional devices (e.g., a device type, model number, serial number, etc.), status information for the habitat functional devices, association information to associate the habitat functional devices 110 with habitat devices, and instruction formats for one or more of the habitat functional devices 110.

The power delivery device 214 operates to deliver power to the habitat functional devices 110 via the connection ports 184. In at least some embodiments, the power delivery device 214 operates to provide power continuously to at least some of the habitat functional devices 110. An example of providing power continuously is providing power whenever the habitat control hub 102 receives power from the power source P. In at least some of these embodiments, the power delivery device 214 is switchless. As an example, a switchless power delivery device does not include an electronically-controllable switch to activate/deactivate power to a particular one of the habitat functional devices 110. A switchless power delivery device may, however, include an overcurrent protection device (e.g., a fuse) that interrupts power delivery to one or more of the habitat functional devices 110 if a dangerous or destructive electrical condition is detected (e.g., an overcurrent condition).

Alternatively, the power delivery device 214 includes one or more switches that operate to enable and disable the delivery of power to a particular one of the habitat functional devices 110. In some embodiments, the power delivery device 214 operates to individually control the power provided to the connection ports 184. For example, the power delivery device 214 may operate to provide different voltage levels or current limits to each of the connection ports 184 (such as based on the type of habitat functional device connected to the connection port or an instruction received from the server 106 or the habitat functional device). In at least some embodiments, the power delivery device 214 includes surge protection circuitry to protect the habitat functional devices 110 from voltage spikes.

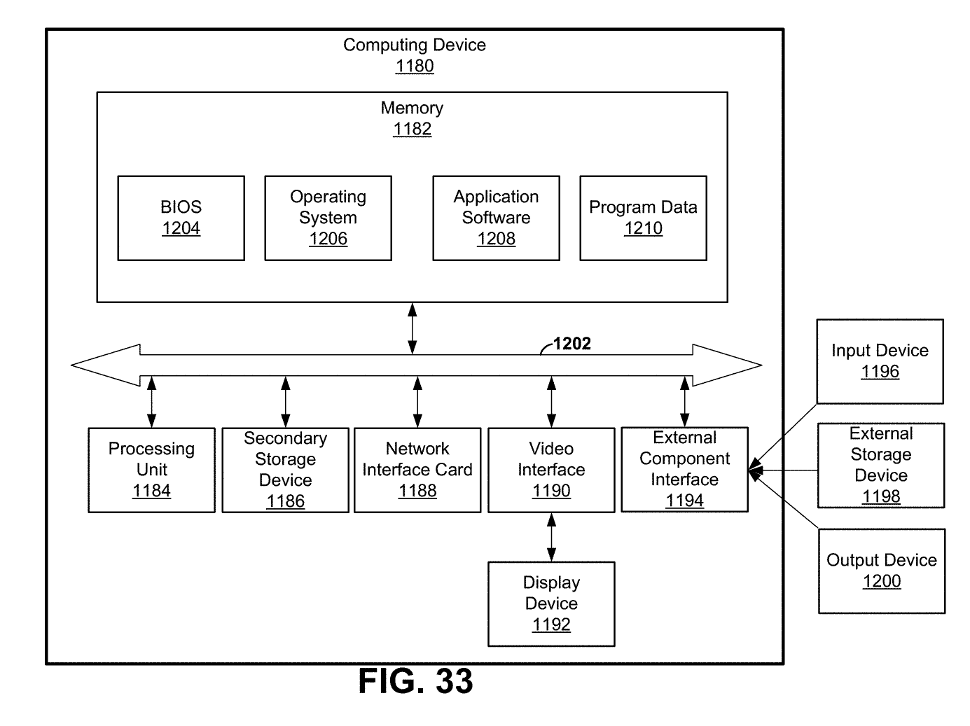

The network interface device 216 is a device that enables the habitat control hub 102 to send and receive data from the network N. The network interface device 216 may be wired or wireless and may use any known network communication protocols. In some embodiments, the network interface device 216 is a network interface card, which is illustrated and described in greater detail with respect to at least FIG. 33.

FIG. 4 is a flow chart illustrating an example method 260 of configuring the habitat control hub 102 to connect to the network N. In some embodiments, the method 260 is performed by the connectivity configuration engine 220. In this example, the method 260 includes operations 262, 264, 266, 268, 270, and 272. However, other embodiments include additional, different, or fewer operations.

In some embodiments, the method 260 is performed if it is determined that the connectivity data 232 in the data store 212 is not set. Additionally, in some embodiments, the method 260 is performed if the habitat control hub 102 is been unable to connect to the network N using the currently stored connectivity data 232 (e.g., the connectivity is incorrect or out-of-date). Additionally, in some embodiments, the method 260 is performed in response to a user input such as a button press or reset command.

At operation 262, an identifier of the habitat control hub 102 is broadcast. In some embodiments, the identifier is a service set identifier (SSID). In other embodiments, the identifier is a Bluetooth name, mac address, or other type of identifier, etc.

At operation 264, a connection request is received from another device, such as the user computing device 104. At operation 266, a connection is formed between the other device and the habitat control hub 102. Various embodiments use various communications protocols. Depending on the protocol used by a particular embodiment, different steps are performed to form the connection.

At operation 268, connectivity data is received from the other device. In some embodiments, the connectivity data includes an identifier of a wireless router or access point and security information necessary to establish a connection with the wireless router or access point. For example, in some embodiments, the connectivity data includes an SSID and key (e.g., a WEP, WPA, or WPA2 key). Additionally, in at least some embodiments, the connectivity data includes information necessary to connect to and login to the server 106.

At operation 270, the habitat control hub 102 connects to the network using at least some of the connectivity data received during operation 268. In some embodiments, the habitat control hub 102 also connects to the server 106 using the connectivity data. At operation 272, the connectivity data is stored (e.g., in the data store 212). In at least some embodiments, the connectivity data is not stored until the habitat control hub 102 has successfully connected to the network N or the server 106 using the connectivity data.

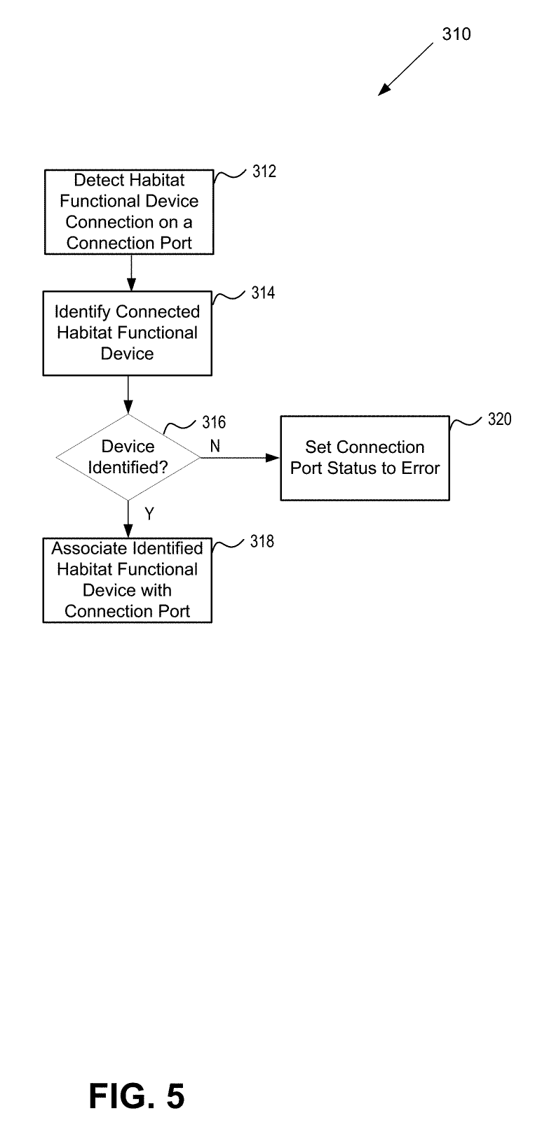

FIG. 5 is a flow chart illustrating an example method 310 of identifying a habitat functional device connected to a connection port of the habitat control hub 102. In some embodiments, the method 310 is performed by the habitat functional device interface engine 222. In this example, the method 310 includes operations 312, 314, 316, 318, and 320. However, other embodiments include additional, different, or fewer operations.

At operation 312, a connection by one of the habitat functional devices 110 to one of the connection ports 184 is detected. In some embodiments, the habitat control hub 102 detects that the connection by detecting a change in a voltage differential between two of the contacts within a connection port. In other embodiments, other techniques for detecting a connection are used, including by detecting other electrical changes, using optical sensors, and using mechanical switches. In some embodiments, the habitat control hub 102 maintains a voltage differential between two of the contacts in each of the connection ports regardless of whether a device is connected. In other embodiments, the habitat control hub 102 generates a voltage differential between contacts in a connection port upon detection of a connection at the connection port.

At operation 314, a connected habitat functional device is identified. In some embodiments, the identity of a connected habitat functional device is determined using an enumeration process such as the USB enumeration process. In some embodiments, the enumeration process includes determining a communication speed for the connected device, sending a reset command to the connected device, and receiving an identifier from the connected device (such as by reading a particular address on the connected device).

In some embodiments, the connected habitat functional device is identified by first performing a USB or similar enumeration process, which among other things establishes a communication channel between the habitat functional device and the hub and appropriate parameters for communication. After the communication channel is established, another enumeration process may be performed to identify the particular type of habitat functional device connected to the hub. An identifier of the habitat functional device (such as a part number) is sent to the hub. The hub then uses the identifier to determine the capabilities of the habitat functional device and the commands that can be sent to the habitat functional device. Alternatively, the habitat control engine 130 determines the capabilities of the habitat functional device and the commands that can be sent to the habitat functional device. After the habitat functional device is identified, the habitat control engine 130 can generate a user interface for display on the user computing device 102 for interacting with the device.

At operation 316, it is determined whether the connected device has been identified. If the connected device has been identified the method 310 continues to operation 318 where the identified habitat functional device is associated with the connection port. In some embodiments, the habitat control hub 102 also determines other information about the connected habitat functional device, such as instruction formats for the connected habitat functional device. Alternatively, the habitat control engine 130 may determine appropriate instruction formats for the connected habitat functional device based on accessing the identification information provided to the habitat control hub. Further, in some embodiments, the habitat control hub 102 may determine power settings for the connected habitat functional device and adjust the power delivery over the connection port appropriately. For example, the habitat control hub 102 may initially maintain a lower power voltage differential between contacts in a connection port so as to minimize the chances of damaging an unidentified device that is connected.

If instead, at operation 316, it is determined that the connected device has not been identified, the method 310 proceeds to operation 320. For example, a connected device may not be identified if it is malfunctioning or if it is not a habitat functional device. At operation 320, the status of the connection port is set to error. In addition to setting the status of the port to error, in some embodiments, an indicator (such as one of the indicators 186) is activated to indicate the error. Further, in some embodiments, the connection port provides less power (or no power) upon failing to identify the connected device. In this manner, the habitat control hub 102 only provides power for known devices that can be identified, which may prevent damaging an unknown device that has different power specifications.

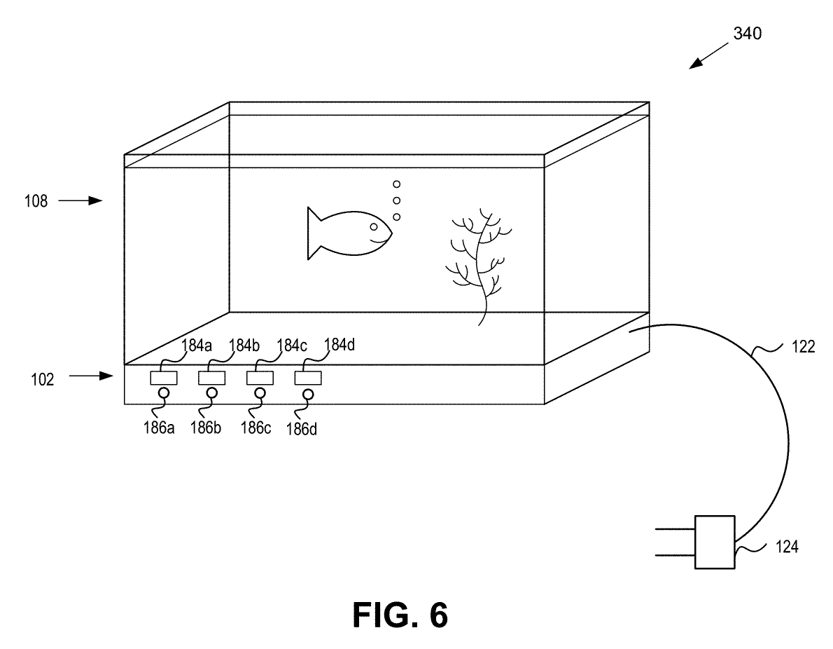

FIG. 6 illustrates an embodiment of a combination device 340 that operates as both the habitat device 108 and the habitat control hub 102. In some embodiments, the combination device 340 includes the habitat device 108 and the habitat control hub 102 in an integral structure. For example, as shown in FIG. 6, the habitat device 108 is an aquarium habitat device and the habitat control hub 102 is included in a base portion of the hub. In some embodiments, the antenna of the habitat control hub 102 is integrated into a wall or corner of the habitat device 108. In alternate embodiments, the habitat control hub 102 is included in a side or top portion of the habitat device 108. Similarly, the connection ports 184 and the indicators 186 are located on different or multiple sides in various embodiments.

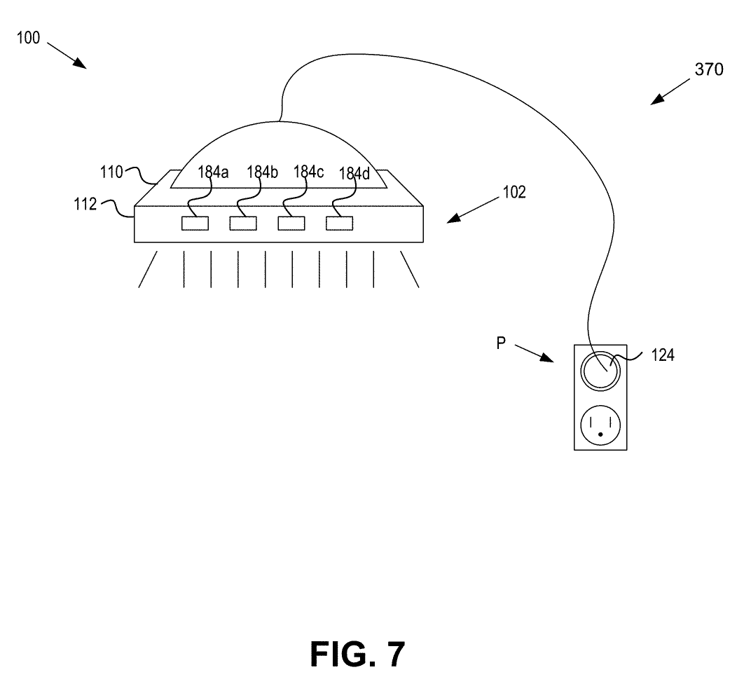

FIG. 7 illustrates another embodiment of a combination device 370 that operates as both the habitat functional device 110 and the habitat control hub 102. In some embodiments, the combination device 370 includes the habitat device 108 and one of the habitat functional devices 110 in an integral structure. For example, as shown in FIG. 7, the habitat control hub 102 is integrated into the light functional device 112. In this manner, other of the habitat functional devices 110 can be connected to the combination device 370, which can serve as both a power source and a controller. The combination device 370 may be beneficial when the light functional device 112 (or any other combined habitat functional device) has a power requirement that exceeds the capabilities of the connection ports 184 on the habitat control hub 102. For example, the light functional device 112 may include high-power LEDs that require more power than is provided by the habitat control hub 102, which may limit current at the connection ports 184 to a predefined threshold such as 100 milliamps, 150 milliamps, 500 milliamps, 900 milliamps, or another current threshold. In these embodiments, the light functional device 112 could not be powered through the connection ports 184.

FIG. 8 illustrates a schematic block diagram of the habitat control engine 130. In some embodiments, the habitat control engine 130 includes a hub interface engine 390, a server interface engine 392, and a user interface engine 394.

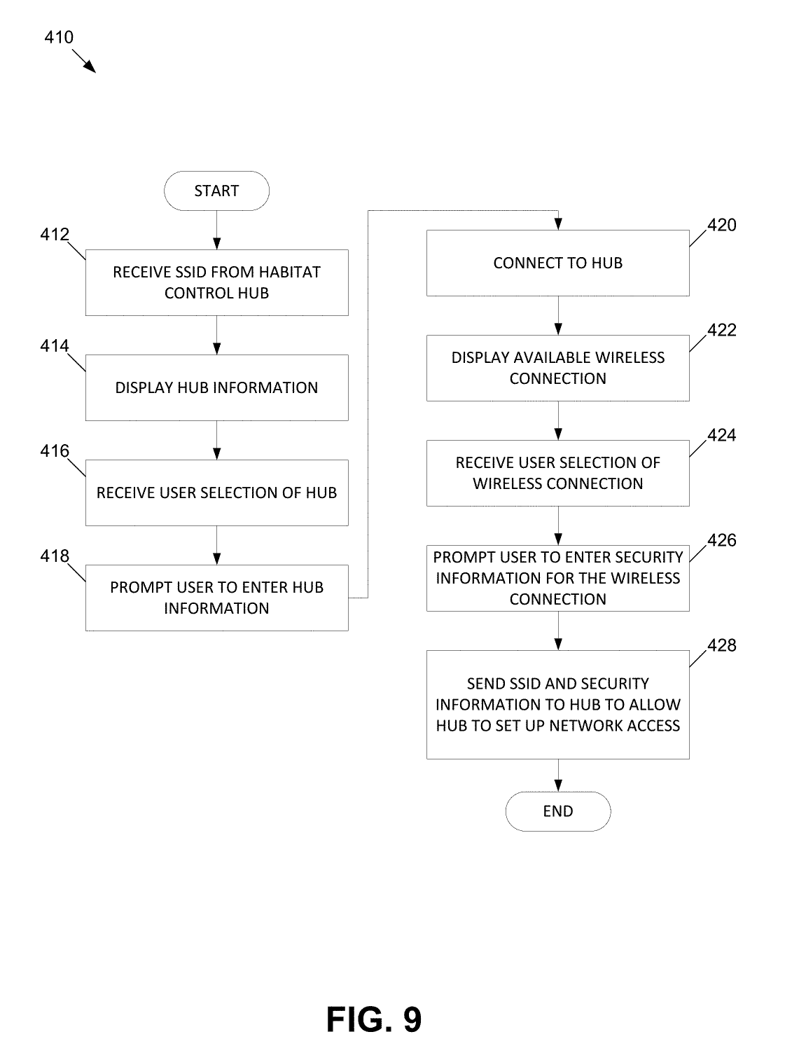

The hub interface engine 390 communicates with the habitat control hub 102. In some embodiments, the hub interface engine 390 communicates with the habitat control hub 102 directly using Wi-Fi or Bluetooth communication protocols. In at least some embodiments, the hub interface engine 390 connects directly to the habitat control hub 102 in order to configure the habitat control hub 102 to connect to the network N or the server 106. Example operations of the hub interface engine 390 are illustrated and described with respect to at least FIG. 9.

The server interface engine 392 communicates with the server 106. In some embodiments, the server interface engine 392 receives information from the server 106 relating to the habitat control hub 102, the habitat device 108, or the habitat functional devices 110. In some embodiments, the server interface engine 392 transmits to the server 106 data and instructions relating to or intended for one or more of the habitat control hub 102, the habitat device 108, or the habitat functional devices 110. Examples of the data and instructions that are transmitted to the server 106 by the server interface engine 392 include instructions to activate or deactivate one of the habitat functional devices 110, instructions to dim or increase the light functional device 112, a sequence (or program) of lighting conditions to be generated over a duration of time by the light functional device 112 or the décor functional device 120, a setting or mode selection for one of the habitat functional devices 110, a schedule for one or more of the habitat functional devices 110, an instruction to capture and transmit images for the camera functional device 118, a temperature setting for the temperature functional device 116, and an instruction to increase or decrease filter pumps for the filter functional device 114. The types of data and instructions that are transmitted by the server interface engine 392 to the server 106 depend on the particular types of habitat functional devices 110 included in the system 100. There are many other examples of data and instructions that are transmitted by the server interface engine 392 to the server 106, some of which are described elsewhere herein.

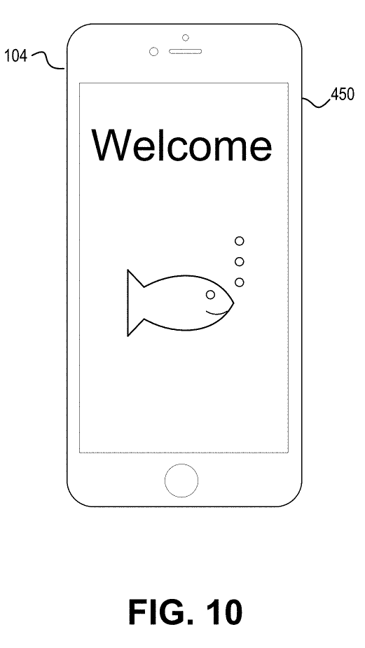

The user interface engine 394 generates user interfaces and receives user inputs. Example user interfaces are illustrated and described with respect to at least FIGS. 10-28.

Some embodiments of the habitat control engine 130 include additional capabilities. For example, in some embodiments, the habitat control engine 130 operates to receive heart-rate (or other physiological) signals from one or more external devices and can correlate the received heart rate with whether the user is watching or interacting with the habitat device 108. Additionally, in at least some embodiments, the habitat control engine 130 operates to identify species of plant and/or animal in the habitat device 108 based on images captured (such as with a camera functional device 118 or a camera of the user computing device 104). In some embodiments, the habitat control engine 130 stores a list of animals and plants in the habitat device 108 and a list of equipment disposed in or associated with the habitat device 108. The habitat control engine 130 may also evaluate the compatibility of the present equipment and species. Further, in some embodiments, the habitat control engine 130 can use the lists of species and equipment to advise the user U regarding potential new additions when the user U is away from the habitat device 108 (e.g., when the user U is at a store considering whether to purchase a new fish).

Some embodiments of the habitat control engine 130 use a camera associated with the user computing device 104 to perform various functions such as determining the size of the habitat device 108 from a captured image or images, determining the equipment, supplies, and species present in or around the habitat device 108 based on images of the equipment or species or by capturing images of barcodes, QR codes, etc. Additionally, when equipment or supplies are identified, the identified equipment or supplies may be added to a user's product library (or inventory list) and instructions and tutorials about the equipment or supplies may be retrieved. Further, based on known properties of the habitat device 108 (e.g., dimensions, species present, etc.) some embodiments of the habitat control engine 130 determine the proper dose (or amount) of a particular supply that should be used. The formulas for calculating the dosing information may be retrieved via the network N and the calculated dosing information may be displayed to the user U and included in various reminders.

Further, in some embodiments, images captured are used to evaluate various properties of the environment within the habitat device 108 such as the water quality or whether various regions are in need of cleaning. This evaluation may be based on visual properties such as the cloudiness of water, etc. Additionally, images may be captured of various testing strips to determine various environmental properties. For example, a test strip may react to the pH level. Similar tests for other environmental properties (such as salinity, alkalinity, specific gravity, nitrate concentration, hardness, chlorine concentration, or ammonia concentration) can be included on a single test strip or on multiple test strips as well. In some embodiments, the image of the test strip is compared to a control image (e.g., an image of the strip captured before testing) to determine the change caused by the environment. Additionally, the image of the test strip may be white balanced before being evaluated to improve accuracy (e.g., to counteract the effect of lighting conditions, etc.). The habitat control engine 130 may then present one or both of a quantitative result (e.g., a numeric pH level) or a qualitative result (e.g., “Safe,” “Caution,” “Danger”). To determine the result, the RGB value of a portion of the strip can be compared to a table stored locally or on the server 106. Along with the result, some embodiments will also present more information about the result and potential causes and consequences of the result.

Additionally, based on the results of the evaluations of the properties of the environment within the habitat device 108, some embodiments recommend water treatment options such as applying appropriate doses of treatment chemicals based on properties of the habitat device 108. If the user has defined multiple habitat devices within the habitat control engine 130, the user will need to identify which habitat environment is being evaluated so that dosing can be properly determined. The habitat control engine 130 can make the recommendations based on applying rules or using formulas that are stored locally. Alternatively, the habitat control engine 130 can make the recommendations based on applying rules or using formulas that are stored remotely on the server 106. One benefit of the habitat control engine basing recommendations on rules or formulas that are stored remotely on the server 106 is that the recommendations can be updated by changing the rules or formulas stored on the server 106. For example, if a new product is released that alters the pH level of aquarium water using a smaller dose than would be needed with previously available products, the rules and formulas on the server 106 can be updated to recommend using the new product and to calculate a proper dose when the new product is used. This update can be made without requiring the user to upgrade/update the habitat control engine 130.

In some embodiments, the habitat control engine 130 will identify multiple potential recommended actions that would each independently remedy a condition determined based on the evaluation of the properties of the environment within the habitat device 108. Although alternatives are possible, the habitat control engine 130 will determine whether the user has any of the products in the potential recommendations to the user's library (product inventory). If so, the habitat control engine 130 will select the recommendation that uses products the user has already indicated owning or having in inventory (rather than recommending that the user purchase a different product). Alternatively, the habitat control engine 130 may select from the multiple potential recommendations based on which recommendation is the most cost effective, which recommendation changes the condition most gradually (e.g., to minimize shock to inhabitants), which recommendation requires the least amount of the user's time or fewest treatments, or which recommendation requires the smallest dose of product.

In some embodiments, multiple test results are considered by the habitat control engine when making a recommendation. In this manner, repetitive recommendations can be combined and the recommendations can be made in the full context of the environmental conditions within the habitat device 108. For example, multiple test results could lead to recommendations to change 25% of the water in an aquarium. In this example, the habitat control engine 130 would combine the recommendations into a single recommendation to change 25% (rather than to change 50%). The recommendations may also include a time frame for when one or more steps need to be performed. The habitat control engine 130 may generate a user interface that allows the user to add reminders to perform the recommended steps in accordance with the recommended time table.

Some embodiments of the habitat control engine 130 operate to acknowledge users for performing certain activities (e.g., changing a filter cartridge, etc.) by awarding a badge which may be shown on a user profile (visible to the user U and optionally other users as well) or by providing special offers or coupons. In some embodiments, the user U may be able access aggregate information from other people in the same region, such as information about local water quality, etc. Some embodiments include capabilities to link data captured, received, or generated by the habitat control engine 130 to community message boards or social media sites.

In some embodiments, the capabilities of the habitat control engine 130 are determined based on the types and quantity of habitat functional devices 110 that are present. For example, various features of the habitat control engine 130 may only be available when a camera functional device 118 has been detected.

In some embodiments, the habitat control engine 130 operates to help the user U find the nearest location (such as based on a location determined with GPS on the user computing device 104) to purchase replacement supplies.

Additionally, embodiments may use the location of the user U to identify other users having similar interest (e.g., that maintain a similar habitat device 108 or raise the same or similar types of plants or animals) that are with a predetermined distance of the user U. Further, in some embodiments, the habitat control engine 130 operates (based on a determined location) allow the user U to interact with products and displays in a store (such as to download additional information about a product, receive electronic coupons or discount offers, and control display panels in the store).

FIG. 9 is a flow chart illustrating an example method 410 of operating the user computing device 104 to configure the habitat control hub 102 to connect to the network N. In some embodiments, the method 410 is performed by the hub interface engine 390. In this example, the method 410 includes operations 412, 414, 416, 418, 420, 422, 424, 426, and 428. However, other embodiments include additional, different, or fewer operations.

In some embodiments, the method 410 is performed when a wireless connection is initially set up between the habitat control hub 102 and the user computing device 104. Once a wireless connection has been initially established to the network N, the user computing device 104 can connect to the habitat control hub 102 via the network N without performing the method 410.

At the operation 412, the hub interface engine 390 of the user computing device 104 receives an SSID of the habitat control hub 102. The SSID may be entered by a user of the user computing device 104. Alternatively, the SSID may be broadcast or otherwise transmitted to the user computing device 104 by the habitat control hub 102. Although the method 410 is described in terms of establishing a connection between the habitat control hub 102 and the user computing device 104 using an SSID (e.g., for wireless communication using WiFi protocols), other embodiments use other or additional communication protocols such as BlueTooth® or ZigBee®. In those embodiments, an appropriate identifier for the communication protocol of the habitat control hub 102 is received by the user computing device 104.

At the operation 414, the hub interface engine 390 displays information about the habitat control hub 102 on the user computing device 104. The information about the habitat control hub 102 is determined based upon the SSID received from the habitat control hub 102. For example, the information that is displayed may indicate that the SSID corresponds to an independent (or standalone) habitat control hub, a habitat control hub that is integrated into a habitat device, or a habitat control hub that is integrated into a habitat functional device.

At the operation 416, the hub interface engine 390 receives a user selection of the habitat control hub 102. When habitat control hubs are detected by the user computing device 104, a list of available habitat control hubs is displayed on the user computing device 104 at the operation 414. A user can select one of the displayed habitat control hubs through the user computing device 104.

At the operation 418, the hub interface engine 390 prompts the user to enter identification information about the selected habitat control hub 102. In some embodiments, the hub interface engine 390 displays a screen asking for specific information identifying the selected habitat control hub 102. For example, the user can type (or otherwise input) relevant identification information through the user computing device 104 as required. The identification information is information unique to the selected habitat control hub 102, such as a serial number or pin. In some embodiments, the identification information is provided with the habitat control hub 102, and the user can find the information and enter the information through the user computing device 104. The operation 418 can ensure a secure connection between the habitat control hub 102 and the user computing device 104.

At the operation 420, the hub interface engine 390 operates to wirelessly connect to the habitat control hub 102 based upon the SSID received at the operation 412 and the identification information received at the operation 418.

At the operation 422, the hub interface engine 390 displays a list of wireless connections that are available to connect to the network N. At the operation 424, the hub interface engine 390 receives a user selection of one of the available wireless connections.

At the operation 426, the hub interface engine 390 prompts the user to enter security information associated with the selected network connection.

At the operation 428, the hub interface engine 390 sends the SSID and security information associated with the selected wireless connection to allow the habitat control hub 102 to set up network access to the network N. Once the network access has been set up, the habitat control hub 102 and the user computing device 104 can communicate via the network N.

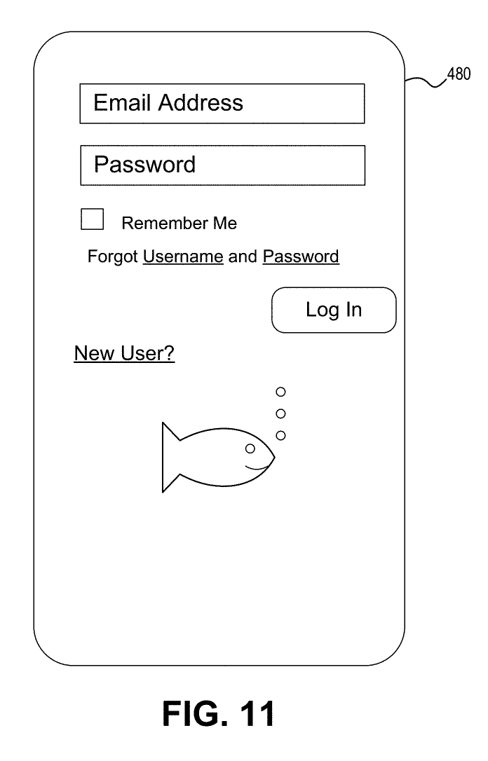

FIG. 10 illustrates an example user interface screen 450 generated by some embodiments of the user interface engine 394 and displayed by some embodiments of the user computing device 104. FIGS. 11-28 show additional example user interface screens that are also generated by some embodiments of the user interface engine 394 and displayed by some embodiments of the user computing device 104. In some embodiments, the habitat control engine 130 is an application (or “App”) for smart phones, table computers, or other computing devices.

Referring again now to FIG. 10, the user interface screen 450 is a welcome screen that is displayed as the habitat control engine 130 is starting.

Referring now to FIG. 11, an example user interface screen 480 for logging in to an account is illustrated. The user U may enter various information to login to an existing account or choose to create a new account. Once entered, the information will be transmitted to the server 106 for authentication.

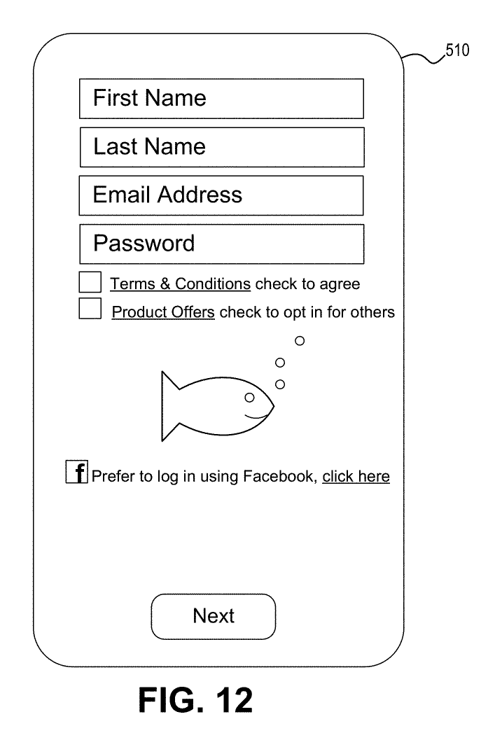

Referring now to FIG. 12, an example user interface screen 510 for creating a new account is illustrated. The user U can enter various information that will be used to establish an account. The information will be transmitted to the server 106 for creation of the account. In some embodiments, the user U can elect to login using an existing account with a third-party service such as Facebook from Facebook, Inc. of Menlo Park, Calif.

Referring now to FIG. 12, an example user interface screen 510 for creating a new account is illustrated.

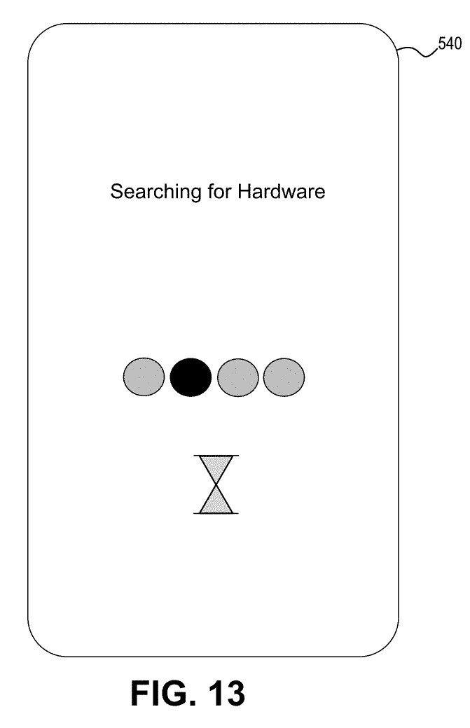

Referring now to FIG. 13, an example user interface screen 540 for finding hardware (e.g., the habitat control hub 102) is illustrated. In some embodiments, the user interface screen 540 is displayed while the user computing device searches for wireless connections with an SSID associated with the habitat control hub 102. Additionally, in some embodiments, one or more animations are displayed on the user interface screen 540 during the search process.

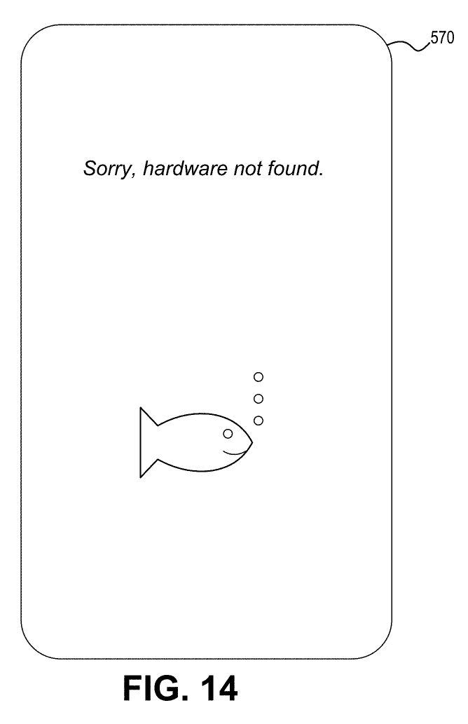

Referring now to FIG. 14, an example user interface screen 570 for hardware not found is illustrated. In some embodiments, the user interface screen 570 is displayed after a predefined time out has expired without finding a wireless connection corresponding to the habitat control hub 102.

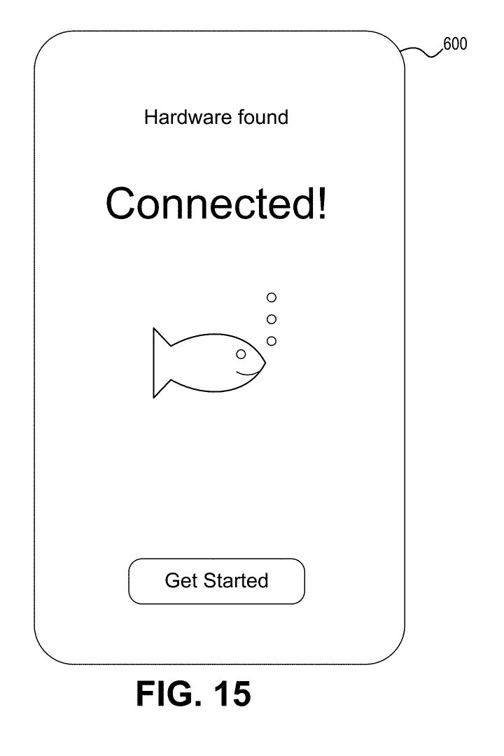

Referring now to FIG. 15, an example user interface screen 600 for getting started with configuring the habitat control hub 102 is illustrated. In some embodiments, the user interface screen 600 is displayed after finding and connecting to a wireless connection corresponding to the habitat control hub 102.

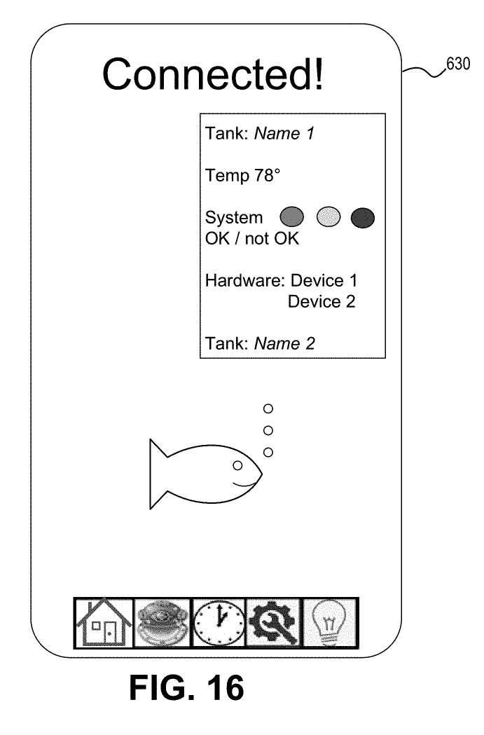

Referring now to FIG. 16, an example user interface screen 630 for displaying information about the habitat device 108 is illustrated. In some embodiments, the user interface screen 630 may operate as a home screen that may be displayed after the application starts up (if at least one hub or habitat device has been configured). In some embodiments, the user interface screen 630 displays information about multiple habitat devices. Examples of information include a list of the connected habitat functional devices 110 and data captured by those habitat functional devices 110. Further, in some embodiments, the background of the user interface screen 630 changes to reflect a status of the habitat device 108. For example, the background may be set to red when there is a problem. Additionally, the user interface screen 630 (as well as other screens) includes a navigation menu in at least some embodiments. The navigation menu includes various menu options such as a home option, a profile option, a notifications option, a settings option, and a hardware control option. Some embodiments display menu options that are not available from the current screen (e.g., inactive buttons) in a greyed out manner to indicate that the options are not available. In some embodiments, the navigation menu includes additional options such as a lighting option, a camera option, and a done option.

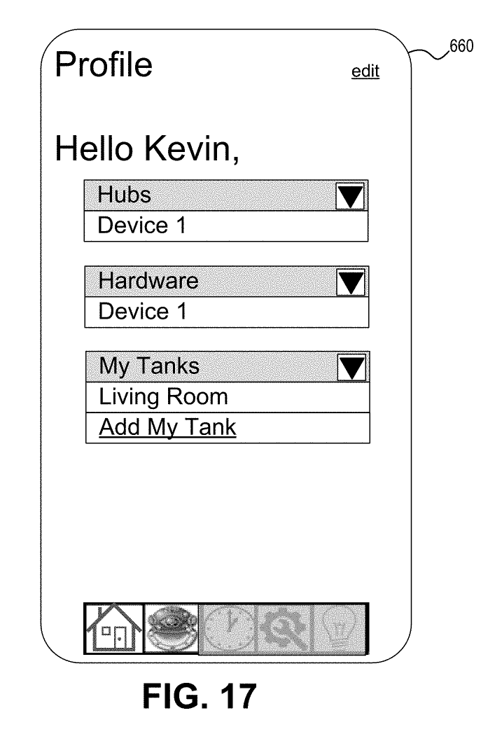

Referring now to FIG. 17, an example user interface screen 660 for selecting components associated with an account is illustrated. In some embodiments, the user U can use the user interface screen 510 to select a particular habitat device, habitat control hub, or habitat functional device.

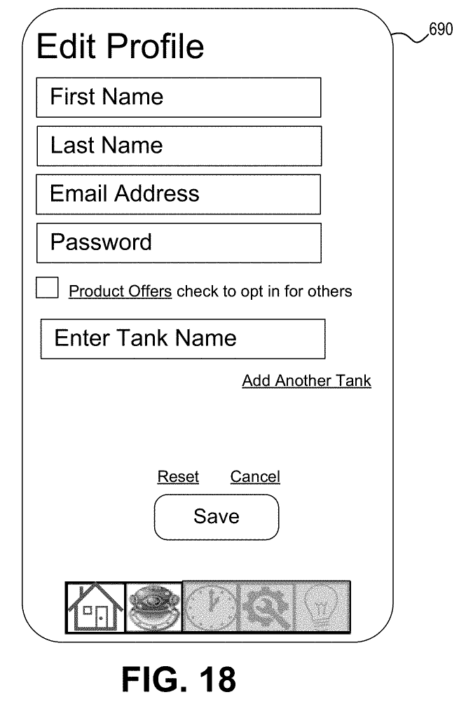

Referring now to FIG. 18, an example user interface screen 690 for editing a user profile is illustrated. The user U may enter various information via the user interface screen 690. The user U may also choose to receive product/promotional offers, which in at least some embodiments are based on the habitats (and animals or plants therein) associated with the account. In some embodiments, the user U may also provide information for a habitat device such as a name, location, size, and type. In some embodiments, the user interface provides text entry fields for information. Additionally, in some embodiments, the user interface provides drop down lists for common types (e.g., freshwater aquarium, saltwater aquarium, and reef aquarium) or sizes of habitat devices. Further, the user U may define multiple habitat devices.

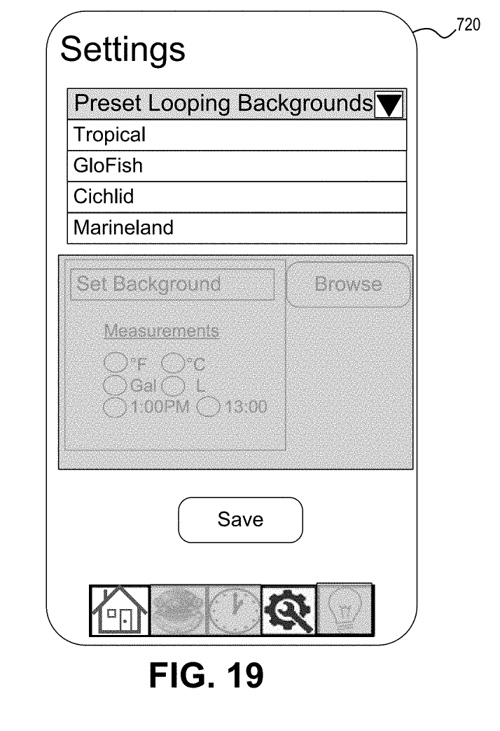

Referring now to FIG. 19, an example user interface screen 720 for adjusting settings is illustrated. In some embodiments, the user U can customize the background of some or all of the user interfaces with the user interface screen 720. In some embodiments, the user U may choose to include an image (including a static image, a prerecorded video, or a live video) of the habitat device 108 as a background. Additionally, in some embodiments the user U can select various display preferences for measurements such as whether to use metric units or Imperial units.

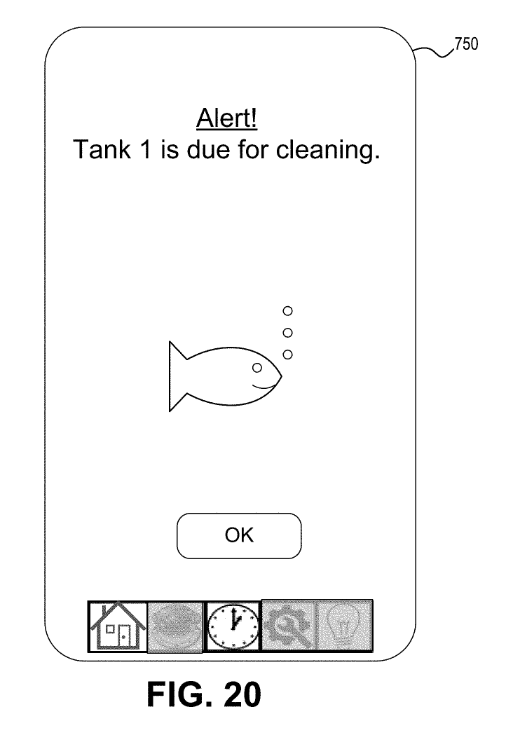

Referring now to FIG. 20, an example user interface screen 750 for displaying notifications is illustrated. In various embodiments, notifications of all sorts are displayed. In some embodiments, when a notification is displayed the user interface screen 750 includes interface controls that allow a user to mark the notification as done, to dismiss the notification, or to request a reminder of the notification at a later time.

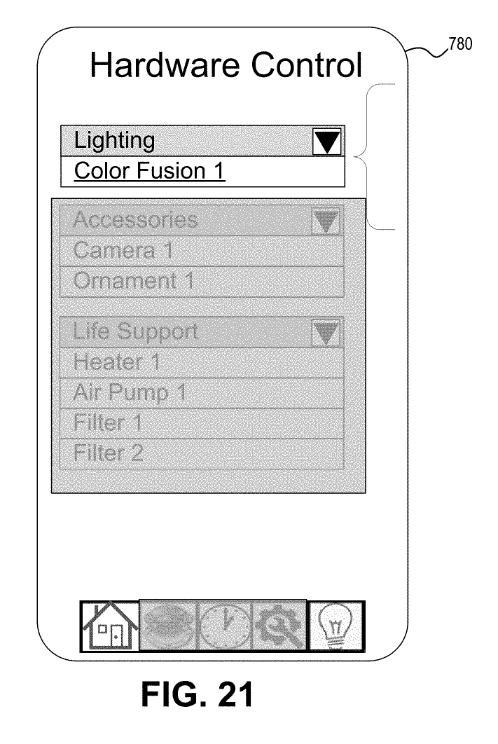

Referring now to FIG. 21, an example user interface screen 750 for controlling the habitat functional devices 110 is illustrated. With the user interface screen 750, the user can select a particular one of the habitat functional devices 110, which may be organized based on the device type or functionality. In at least some embodiments, the list of connected habitat functional devices 110 is retrieved from the server 106.

Some embodiments allow a user to select and control a single one of the habitat functional devices 110. Alternatively, some embodiments allow a user to select multiple habitat functional devices 110 for simultaneous control. For example, a user could activate an RGB light with a low blue color and an ultraviolet light simultaneously to enhance display of the environment or a portion thereof (such as a reef).

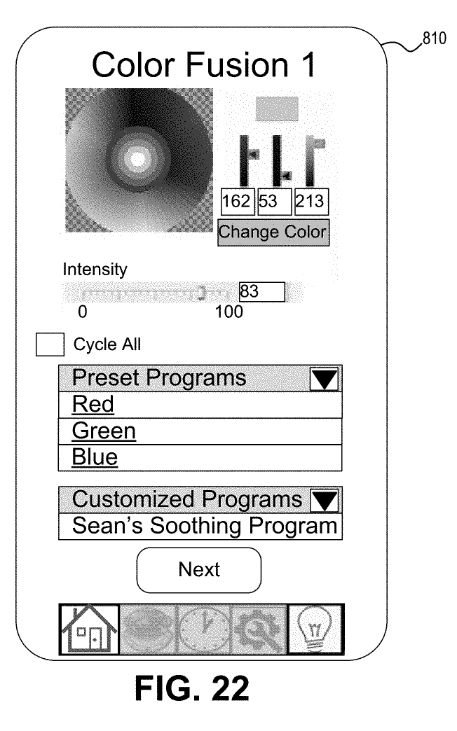

Referring now to FIG. 22, an example user interface screen 780 for controlling the light functional device 112 is illustrated. With user interface screen 780, the user U can select from a number of preset and customized programs for light control. Alternatively, the user U can also adjust individual settings for the light functional device 112.

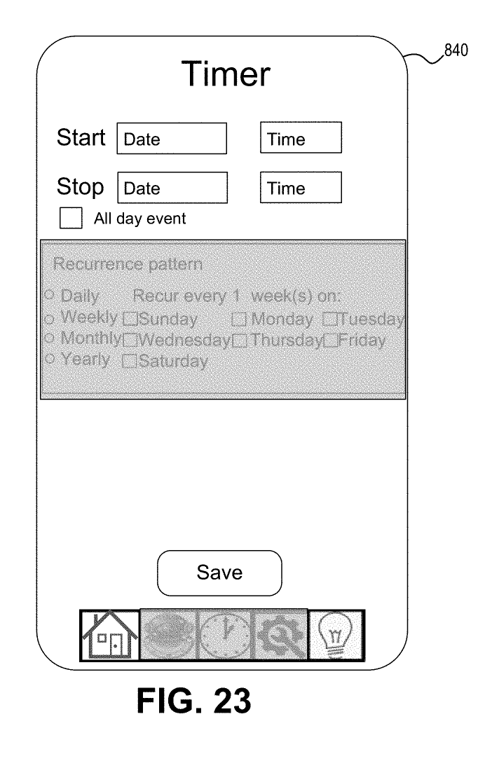

Referring now to FIG. 23, an example user interface screen 840 for creating a timer is illustrated. For example, the timer may be used to control one or more of the habitat functional devices 110, display reminders, or transition between phases in a lighting program. In some embodiments, the timers are simple timers that turn a particular habitat functional devices 110 on or off at a particular time. In some embodiments, the timers are complex timers that run specific programs (e.g., lighting programs) and other functions at designated times and in designated orders.

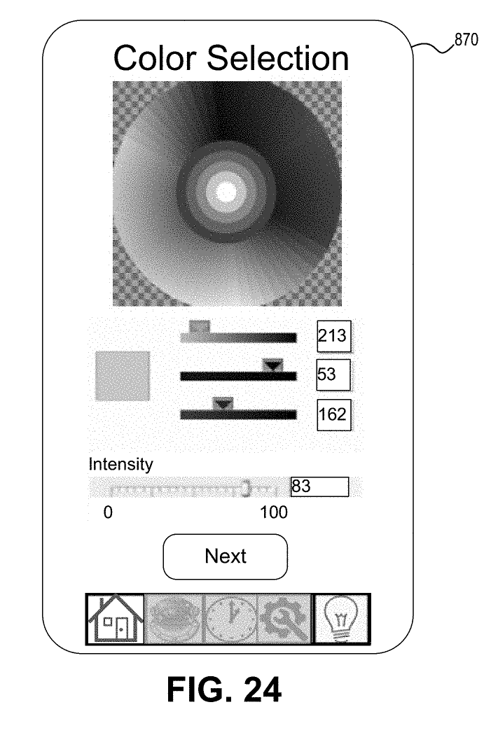

Referring now to FIG. 24, an example user interface screen 870 for adjusting a lighting program is shown. In some embodiments, a lighting program includes multiple phases, wherein each of the phases includes lighting settings. In some embodiments, the lighting settings include color and intensity values for one or more light functional devices. The phases may also include a duration value to indicate a duration of time for which the lighting program should remain in the phase. In some embodiments, the phases also include additional lighting instructions to specify various lighting patterns or modes as described herein (e.g., fade, flash, move, etc.).

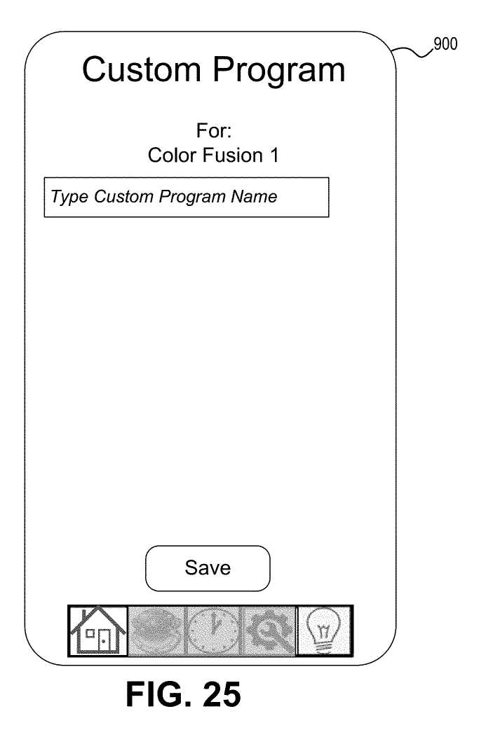

Referring now to FIG. 25, an example user interface screen 900 for saving a lighting program is shown. In some embodiments, the user U can create many lighting programs each having different names. In some embodiments, the lighting program is saved to the server 106.

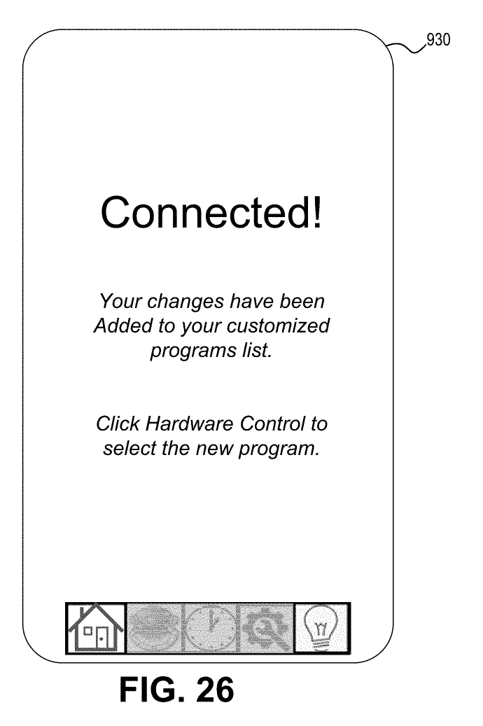

Referring now to FIG. 26, an example user interface screen 930 for indicating success creating a new lighting program is shown. In at least some embodiments, the user interface screen 900 is displayed after the server 106 has indicated that the lighting program has been saved.

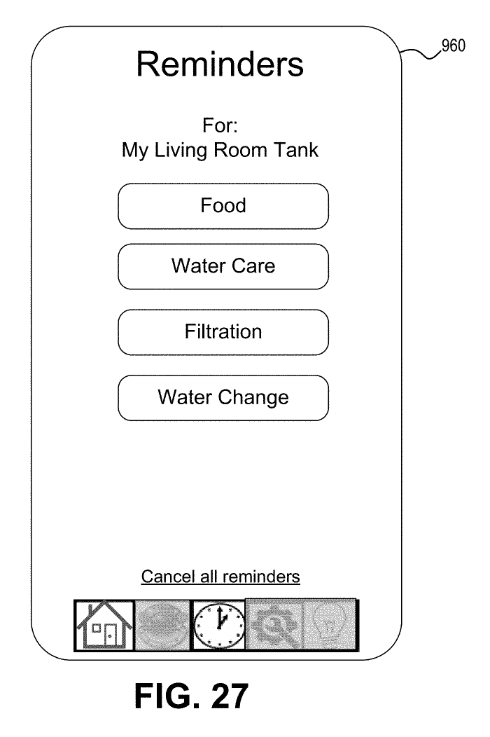

Referring now to FIG. 27, an example user interface screen 960 for managing reminders is shown. In some embodiments, reminders are specific to a particular habitat device. In addition, the reminders may be organized based on type. Example types of reminders include food reminders that relate to feeding an animal in the habitat, water care reminders that relate to testing and caring for the water in the habitat (e.g., to test the water using a test strip or to replace a portion of the water), filtration reminders that relate to replacing components (e.g., carbon cartridges) in the filter functional device 114, and water change reminders that relate to replacing some or all of the water in the habitat. Some embodiments include other types of reminders as well. In some embodiments, the reminders are set or cleared based on the occurrence of particular actions (e.g., a reminder to test water quality may be cleared when a test strip is imaged and analyzed). Additionally, some reminders may relate to particular animals or plants within the habitat device 108. For example, in some embodiments, the reminders may include anniversaries (monthly, annual, etc.) of when a particular animal or plant specimen was added to the habitat device 108 (e.g., “Say happy birthday to your clownfish,” etc.). Further, in some embodiments, the reminders may include marketing content or offers (e.g., “Give your fish some birthday treats from Tetra®,” etc.).

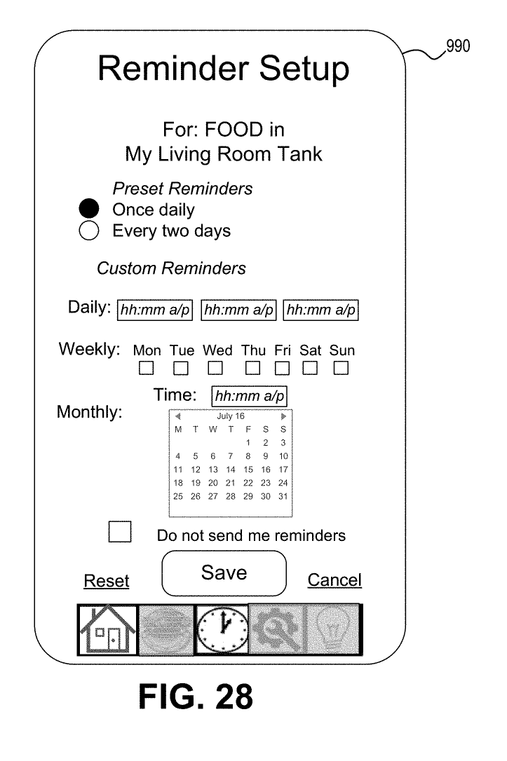

Referring now to FIG. 28, an example user interface screen 990 for editing reminders is shown. The user U may set various parameters of a reminder using the user interface screen 990. Example parameters include a due date and time, a recurrence frequency, and a status (due, overdue, done on, etc.). In some embodiments, the reminders are sent via e-mail, SMS message, or various push messaging formats. In some embodiments, the reminders are notifications that are displayed on the user computing device 104. In addition to reminders, the habitat control engine 130 may send various helpful hints to users as well.

In addition to sending reminders (or notifications) based on a schedule, some embodiments send reminders based on detecting a particular condition that may need to be remedied. For example, some embodiments send notifications upon detecting a temperature that is outside of a predetermined range. Additionally, the reminders may include notices to perform preventative maintenance or other tasks. In some embodiments, the reminders may include offers or discounts on replacement parts or supplies that are sent at appropriate intervals based on expected utilization and durability. Reminders may also be sent based on the warranty associated with the various components (e.g., the habitat functional devices 110 and the habitat control hub 102). For example, an offer to purchase an extended warranty may be sent in advance of the expiration of the warranty on the components (which may be measured from when the component was first provisioned to the user U).

FIG. 29 illustrates a schematic block diagram of the habitat interface engine 140. In some embodiments, the habitat interface engine 140 includes a web interface engine 1090, a data management engine 1092, a hub interface engine 1094, and a user computer interface engine 1096.

The web interface engine 1090 operates to generate web pages and to respond to various hypertext transport protocol (HTTP/HTTPS) requests. In some embodiments, the web interface engine 1090 generates web pages that provide functionality similar to that provided by the user interface engine 394 described previously and can be used to manage and control the habitat functional devices 110 connected to one or more habitat control hubs 102. Beneficially, the user U can access the web server from any computing devices that includes a web browser.

The data management engine 1092 operates to store and manage data. In some embodiments, the data relates to the habitat control hubs, habitat functional devices, user accounts, user profiles, instructions/commands that have been issued, instructions/commands that are waiting to be issued, inventory information for users, and other types of information. Additionally, in some embodiments, the data management engine 1092 stores information used to control the habitat functional devices 110 (e.g., instruction format and arguments, etc.).

In some embodiments, the data management engine 1092 stores serial numbers associated with each of the habitat functional devices 110. In addition, in some embodiments, the serial number is associated with a device type, which may also be associated with an instruction set for the device type. Beneficially, this data can be retrieved by the habitat control hub 102 to identify a connected device. Further, in some embodiments, the data management engine 1092 also associates the serial numbers of the habitat functional devices 110 with a user account. In some embodiments, the data management engine 1092 stores or generates warranty and other support information based on associating one of the habitat functional devices 110 (or the habitat control hub 102) with a particular user. In some embodiments, user accounts are associated with more than one habitat device and so the data management engine 1092 also stores data to associate (or assign) the devices with a particular habitat device.

The hub interface engine 1094 operates to communicate with the habitat control hub. For example, when the server 106 receives an instruction for a particular habitat functional device, the server 106 transmits that instruction to the associated habitat control hub. In some embodiments, the hub interface engine 1094 includes a service that actively transmits the instruction to the habitat control hub 102 (such as by connecting to a port on which a service is listening on the habitat control hub 102). Alternatively, the hub interface engine 1094 stores instructions in an instruction queue for the habitat control hub 102 that the habitat control hub 102 checks periodically.

The user computer interface engine 1096 operates to communicate with the user computing device 104. In some embodiments, the user computer interface engine 1096 provides various interfaces that the habitat control engine 130 uses to retrieve that data necessary to perform the functions and generate the interfaces described herein.

In various embodiments, the habitat interface engine 140 includes various other engines as well. Examples of additional engines include a marketing data analysis engine to analyze product and inventory use and purchasing for users (or aggregated groups of users), a trend analysis engine to analyze use and purchasing information, a notification engine to transmit notices or alerts to users, a third-party integration engine for connecting with third-party services such as social media services and home automation services for information and control sharing purposes.

FIG. 30 illustrates a schematic block diagram of an embodiment of the habitat functional device 110. In some embodiments, the habitat functional device 110 includes a function performing device 1100, a power receiving device 1102, an identification engine 1104, and a hub interface engine 1106.

The function performing device 1100 performs a function. Examples of functions performed by embodiments of the function performing device 1100 include emitting light, filtering water or other substances, maintaining or measuring a temperature, capturing still images or video images, evaluating an environmental characteristic, pumping water or other substances, and emitting bubbles.

The power receiving device 1102 operates to receive power from the habitat control hub 102. In some embodiments, the power receiving device 1102 distributes power to one or more of the other components within the habitat functional device 110. In some embodiments, the power receiving device 1102 is configured to receive power as a voltage differential between two wires in the cable 126.

The identification engine 1104 operates to identify the habitat functional device 110. In some embodiments, the identification engine 1104 operates to identify a type of the habitat functional device 110 such as with a device class number, model number, or type name. Additionally, in some embodiments, the identification engine 1104 operates to identify a particular habitat functional device 110, such as with a serial number, unique identifier, or the like. In some embodiments, the identification engine comprises a memory device that stores various identification data.

The hub interface engine 1106 operates to communicate with the habitat control hub 102. In some embodiments, the hub interface engine 1106 receives instructions for the function performing device 1100 from the habitat control hub 102. Additionally, in some embodiments, the hub interface engine 1106 operates to transmit data captured or generated by the function performing device 1100. In some embodiments, the hub interface engine 1106 also transmits information from the identification engine 1104 to the habitat control hub 102 to identify the habitat functional device 110. In some embodiments, the hub interface engine 1106 communicates with the hub via two wires in the cable 126 that form a twisted pair and operate as a serial bus.

Various embodiments of the hub interface engine 1106 are configured to communicate with habitat control hub 102 using various instructions formats. For example, instructions may be received in the data section of a packet formatted according to the USB 2.0 specification. In some embodiments, the instructions include various instructions that control the operation of the function performing device 1100.

For example, embodiments of the light functional device 112 are configured to receive instructions (commands) to emit light according to one or more of the following patterns (or modes): a static color (which may be specified by parameters in any color space, such as RGB, CYMK, LMN, etc.), a repeated cyclic fade through a sequence of predefined colors over a specified cycle time, a repeated flashing pattern over a specified cycle time, a fade from a specified start color to a specified final color over a specified time period, a fade from a specified start color to a specified midway color and then to a specified final color over a specified time period, various combinations of previously described or other patterns (which may repeat, may be specified as a list, and may specify time durations for each pattern), a moving light pattern (where different colors of light are emitted from different portions of a lighting device and the colors change to create an effect of movement across the light). In some embodiments, the instructions activate (or select) a particular mode for the light functional device 112. Additionally, in some embodiments, the instructions specify parameters for a particular one of the modes (e.g., colors, intensities, durations, etc.).

In some embodiments, the parameters specified in an instruction for a particular mode are stored in a memory on the light functional device 112. In this manner, the specified parameters can be re-used each time that particular mode is selected until new parameters are specified in an instruction. Once a particular mode has been selected and communicated to the light functional device 112, the light functional device 112 will continue to operate in that particular mode until new instructions are received. In addition to the light functional device 112, other types of functional device can operate similarly (e.g., receive an instruction from the hub and operate according to a mode specified in the instruction until a new instruction is received from the hub). A potential benefit of these embodiments is that because the functional devices can operate autonomously based on a specified mode, the hub does not need to send instructions to the functional device as often and can therefore use less power.

Although alternatives are possible, the habitat functional devices can selectively operate in either a “connected” mode or an “independent” mode. When first powered up, the habitat functional devices operate in the independent mode and exhibit a default behavior such as responding to a physical button or other type of tactile input control device to activate/deactivate various capabilities (e.g., switch between lighting effects). The habitat functional devices enter the connected mode after being identified (enumerated) by the habitat control hub (e.g., as illustrated and described with respect to FIG. 5) and receiving a first command from the habitat control hub. For example, the habitat interface engine of the habitat control device may disable operation of the tactile input control devices on the habitat functional devices when the habitat functional devices are operating in the connected mode. Conversely, the habitat interface engine may re-enable operation of the tactile input control devices when the habitat functional devices are operating in the independent mode. A benefit of this design is that the habitat functional devices can function independently when powered by other means than the hub, such as a USB charging adapter, allowing the end-user to upgrade a habitat functional device and reuse the older item for others means without requiring a habitat control hub. It also allows all habitat functional devices to operate, and potentially provide life preserving actions, while the habitat control hub is otherwise occupied on other tasks, such as performing an upgrade, while still providing the continuous power source to all connected habitat functional devices.

Some embodiments include additional modes for the lights such as to emulate outdoor conditions such as sunrise, sunset, passing clouds, lightning, etc. These embodiments may include instructions to select any additional lighting modes that are included.

In some embodiments, the habitat control hub 102 transmits instructions to the light functional device 112 to synchronize the emitted light with music or sound effects being played on the user computing device 104 (e.g., by pulsing the emitted light in sync with the beat of a song). Further, in some embodiments, the habitat control hub 102 may control the lights based on external information such as local weather or remote weather. For example, if the habitat device 108 houses a Malawi Cichlid, the habitat control hub 102 may transmit instructions to cause the lighting match current conditions (e.g., cloud cover, lightning, sun and moon position, etc.) in Malawi. In another example, an instruction may be transmitted to cause the lights to flash or otherwise indicate a warning condition such as that a temperature has exceeded a predefined threshold.

Additionally, in some embodiments, the light functional device 112 is configured to receive instructions that request information about the light functional device 112. For example, embodiments of the light functional device 112 are configured to receive instructions to return information about the light functional device 112 relating to one or more of the following: a current mode, a product type, a product ID, a serial number, a manufacturing date.

Further, some embodiments of the light functional devices 112 include timers and operate to receive instructions to set the timers to activate or deactivate the light functional devices 112 according to a specified schedule. The timers may use a clock included in some embodiments of the light functional devices 112 (which may be automatically set by the habitat control hub 102). Additionally, in some embodiments, the habitat control hub 102 or the habitat control engine 130 includes timers and issues instructions (or commands) to active/deactivate the light functional devices 112 according to a specified schedule. Additionally, rather than deactivating the light functional devices 112, in some embodiments the light functional devices 112 may be set to an “energy-savings mode” that uses less power according to a specified schedule.

In some embodiments, the energy-savings mode may operate to disable or lower the activity level of various of the habitat functional devices 110 (besides the light functional devices 112). Some embodiments include other modes that affect multiple of the habitat functional devices 110 as well. For example, some embodiments include a “feeding” mode where the filter functional device 114 reduces flow or stops and the light functional device 112 and camera functional device 118 are activated. As another example, some embodiments include a “water change” mode where the light functional device 112, temperature functional device 116, and filter functional device 114 are deactivated for a prescribed period of time. Other embodiments include other modes as well.

Additionally, in some embodiments, other types of the habitat functional devices 110 operate to receive different types of instructions (commands). For example, embodiments of the camera functional device 118 operate to receive instructions to capture a still image, to begin to capture video images, to stop capturing video images, and to begin streaming video to the user computing device 104 (e.g., via WiFi directly, or an Internet-based server, etc.).

FIG. 31 illustrates an embodiment of a wireless communication device 1140 for use with embodiments of the habitat functional devices 110, such as the décor functional device 120. In some embodiments, the wireless communication device 1140 is connected to the habitat control hub 102 and operates to facilitate wireless communication between the habitat control hub 102 and the décor functional device 120 (e.g., using near field communication, radio frequency identification, or other wireless communication technologies). Additionally, in some embodiments, the wireless communication device 1140 operates to provide power to the décor functional device 120 wirelessly (e.g., using inductive power transfer). In some embodiments, the wireless communication device 1140 comprises a mat or similar structure upon which the habitat device 108 may be placed. In some embodiments, the wireless communication device 1140 is sized to fit in a cavity on the underside of the habitat device 108 or in a cavity formed in a base structure of the habitat device 108. Further in some embodiments, the wireless communication device 1140 is configured to be attached to a side of the habitat device 108.

FIG. 32 shows additional details of some embodiments of the wireless communication device 1140. In this example, the wireless communication device 1140 is in wireless communication with one of the habitat functional devices 110. Specifically, in this example, the wireless communication device 1140 is in wireless communication with the décor functional device 120.

In the embodiment shown in FIG. 32, the wireless communication device 1140 includes an inductive coil 1142 and a radio frequency identification (RFID) reader 1144. In the embodiment shown in FIG. 32, the décor functional device 120 includes an inductive coil 1146 and a RFID tag 1148.

In some embodiments, the inductive coil 1142 of the wireless communication device 1140 operates to generate a magnetic field that will induce a current in the inductive coil 1146 of the décor functional device 120 when the décor functional device 120 is proximate to the wireless communication device 1140. The current induced in the inductive coil 1146 is used to power various functions within the décor functional device 120 such as the emission of light. In addition, the current generated by the wireless communication device 1140 in the inductive coil 1142 may be pulsed or modulated to encode instructions or other data to be transmitted wirelessly to the décor functional device 120. In some embodiments, additional wireless transmitters and/or receivers (e.g., additional inductive coils, Wi-Fi transceivers, Bluetooth transceivers, etc.) are included in one or both of the wireless communication device 1140 and the décor functional device 120 to further facilitate wireless communication therebetween.

The RFID reader 1144 operates to read the RFID tag 1148. In some embodiments, the RFID tag 1148 operates to transmit identification information from the décor functional device 120 to the wireless communication device 1140 such as a device class (or type) and a serial number. In some embodiments, the RFID tag 1148 is a passive tag. In other embodiments, the RFID tag 1148 is an active or battery-assisted passive tag.

Some embodiments of the wireless communication device 1140 may include multiple inductive coils to transmit power and/or instructions to multiple of the habitat functional devices 110 disposed in multiple locations relative to the wireless communication device 1140.

In some embodiments, the wireless communication device 1140 is configured to receive information from the décor functional device 120 such as measurements (e.g., temperature, water quality, etc.). In some embodiments, the wireless communication device 1140 transmits instructions to one or more décor functional devices 120 to actuate lights (or other elements) of the décor functional devices 120 in sync with music or sound effects being played on the user computing device 104. Additionally, in some embodiments, the wireless communication device 1140 transmits instructions to one or more of the décor functional devices 120 that cause the décor functional devices 120 to convey information to the user U, such as by emitting (or flashing) red (or another color) light when the user U needs to take a particular action.

In some embodiments, the system 100 provides feedback and information to users in one or more ways such as by presenting information to the user through the user computing device 104 or by modifying the behavior of the décor functional devices 120. For example, some embodiments presenting information to the user by changing colors on the décor functional devices 120, illuminating a warning light (on one or more of the décor functional devices 120 or elsewhere), emitting warning sounds or other alarms, or and presenting feedback by other methods.

FIG. 33 is a block diagram illustrating example physical components of a computing device 1180. In some embodiments, the computing device 1180 is implemented using multiple computing devices. It should be appreciated that in other embodiments, the computing device 1180 is implemented using physical components other than those illustrated in the example of FIG. 33. In some embodiments, the computing device 1180 is used to implement one or more of the habitat control hub 102, the user computing device 104, or the server 106.

In the example of FIG. 33, the computing device 1180 comprises a memory 1182, a processing unit 1184, a secondary storage device 1186, a network interface card 1188, a video interface 1190, a display device 1192, an external component interface 1194, an input device 1196, an external storage device 1198, an output device 1200, and a communications medium 1202. In other embodiments, computing devices are implemented using more or fewer hardware components. For instance, in another example embodiment, a computing device does not include a video interface, a display device, an external storage device, or an input device.

The memory 1182 includes one or more computer-readable data storage media capable of storing data or instructions or both. In different embodiments, the memory 1182 is implemented in different ways. For instance, in various embodiments, the memory 1182 is implemented using various types of computer-readable data storage media. Example types of computer-readable data storage media include, but are not limited to, dynamic random access memory (DRAM), double data rate synchronous dynamic random access memory (DDR SDRAM), reduced latency DRAM, DDR2 SDRAM, DDR3 SDRAM, Rambus RAM, solid state memory, flash memory, read-only memory (ROM), electrically-erasable programmable ROM, and other types of devices and/or articles of manufacture that store data. In some embodiments, the memory 1182 includes non-transitory media.

The processing unit 1184 includes one or more physical integrated circuits that selectively execute software instructions. In various embodiments, the processing unit 1184 is implemented in various ways. For instance, in one example embodiment, the processing unit 1184 is implemented as one or more processing cores. For instance, in this example embodiment, the processing unit 1184 may be implemented as one or more Intel Core 2 microprocessors. In another example embodiment, the processing unit 1184 is implemented as one or more separate microprocessors. In yet another example embodiment, the processing unit 1184 is implemented as an ASIC that provides specific functionality. In yet another example embodiment, the processing unit 1184 provides specific functionality by using an ASIC and by executing software instructions.

In different embodiments, the processing unit 1184 executes software instructions in different instruction sets. For instance, in various embodiments, the processing unit 1184 executes software instructions in instruction sets such as the x86 instruction set, the POWER instruction set, a RISC instruction set, the SPARC instruction set, the IA-64 instruction set, the MIPS instruction set, and/or other instruction sets.

The secondary storage device 1186 includes one or more computer-readable data storage media. The secondary storage device 1186 stores data and software instructions not directly accessible by the processing unit 1184. In other words, the processing unit 1184 performs an I/O operation to retrieve data and/or software instructions from the secondary storage device 1186. In various embodiments, the secondary storage device 1186 is implemented by various types of computer-readable data storage media. For instance, the secondary storage device 1186 may be implemented by one or more magnetic disks, magnetic tape drives, CD-ROM discs, DVD-ROM discs, Blu-Ray discs, solid state memory devices, Bernoulli cartridges, and/or other types of computer-readable data storage media. In some embodiments, the secondary storage device 1186 includes non-transitory media.

The network interface card 1188 enables the computing device 1180 to send data to and receive data from a computer communication network. In different embodiments, the network interface card 1188 is implemented in different ways. For example, in various embodiments, the network interface card 1188 is implemented as an Ethernet interface, a token-ring network interface, a fiber optic network interface, a wireless network interface (e.g., WiFi, WiMax, etc.), or another type of network interface.

The video interface 1190 enables the computing device 1180 to output video information to the display device 1192. In different embodiments, the video interface 1190 is implemented in different ways. For instance, in one example embodiment, the video interface 1190 is integrated into a motherboard of the computing device 1180. In another example embodiment, the video interface 1190 is a video expansion card. Example types of video expansion cards include Radeon graphics cards manufactured by ATI Technologies, Inc. of Markham, Ontario, GeForce graphics cards manufactured by NVidia Corporation of Santa Clara, Calif., and other types of graphics cards.

In various embodiments, the display device 1192 is implemented as various types of display devices. Example types of display devices include, but are not limited to, cathode-ray tube displays, LCD display panels, plasma screen display panels, touch-sensitive display panels, LED screens, projectors, and other types of display devices. In some embodiments, the display device 1192 is integral with the computing device 1180. However, in other embodiments, the display device 1192 is a separate component from the computing device 1180. In various embodiments, the video interface 1190 communicates with the display device 1192 in various ways. For instance, in various embodiments, the video interface 1190 communicates with the display device 1192 via a Universal Serial Bus (USB) connector, a VGA connector, a digital visual interface (DVI) connector, an S-Video connector, a High-Definition Multimedia Interface (HDMI) interface, a DisplayPort connector, or other types of connectors.

The external component interface 1194 enables the computing device 1180 to communicate with external devices. In various embodiments, the external component interface 1194 is implemented in different ways. For instance, in one example embodiment, the external component interface 1194 is a USB interface. In other example embodiments, the external component interface 1194 is a FireWire interface, a serial port interface, a parallel port interface, a PS/2 interface, and/or another type of interface that enables the computing device 1180 to communicate with external components.

In different embodiments, the external component interface 1194 enables the computing device 1180 to communicate with different external components. For instance, in the example of FIG. 3, the external component interface 1194 enables the computing device 1180 to communicate with the input device 1196, and the external storage device 1198. In other embodiments, the external component interface 1194 enables the computing device 1180 to communicate with more or fewer external components. Other example types of external components include, but are not limited to, speakers, phone charging jacks, modems, media player docks, other computing devices, scanners, digital cameras, a fingerprint reader, and other devices that can be connected to the computing device 1180.

The input device 1196 is a component that provides user input to the computing device 1180. Different implementations of the computing device 1180 interface with different types of input devices. Example types of input devices include, but are not limited to, keyboards, mice, trackballs, stylus input devices, key pads, microphones, joysticks, touch-sensitive display screens, and other types of devices that provide user input to the computing device 1180. In some embodiments, the input device 1196 is external to the computing device 1180, while in other embodiments the input device 1196 is integral to the computing device 1180. In some embodiments, the input device 1196 communicates with the computing device 1180 through the external component interface 194, while in other embodiments, the input device 1196 communicates with the computing device 1180 through in other interfaces, such as through an interface integrated into a motherboard of the computing device 1180.

The external storage device 1198 is an external component comprising one or more computer readable data storage media. Different implementations of the computing device 1180 interface with different types of external storage devices. Example types of external storage devices include, but are not limited to, magnetic tape drives, flash memory modules, magnetic disk drives, optical disc drives, flash memory units, zip disk drives, optical jukeboxes, and other types of devices comprising one or more computer-readable data storage media. In some embodiments, the external storage device 1198 includes non-transitory media.

The output device 1200 is a component that the computing device 1180 uses to provide output. Different implementations of the computing device 1180 interface with different types of output devices. A printer is an example of an output device 1200.

The communications medium 1202 facilitates communication among the hardware components of the computing device 1180. In different embodiments, the communications medium 1202 facilitates communication among different components of the computing device 1180. For instance, in the example of FIG. 33, the communications medium 1202 facilitates communication among the memory 1182, the processing unit 1184, the secondary storage device 1186, the network interface card 1188, the video interface 1190, and the external component interface 1194. In different implementations of the computing device 1180, the communications medium 1202 is implemented in different ways. For instance, in different implementations of the computing device 1180, the communications medium 1202 may be implemented as a PCI bus, a PCI Express bus, an accelerated graphics port (AGP) bus, an InfiniBand interconnect, a serial Advanced Technology Attachment (ATA) interconnect, a parallel ATA interconnect, a Fiber Channel interconnect, a USB bus, a Small Computer System Interface (SCSI) interface, or another type of communications medium.

The memory 1182 stores various types of data or software instructions or both. For instance, in the example of FIG. 33, the memory 1182 stores a Basic Input/Output System (BIOS) 1204, an operating system 1206, application software 1208, and program data 1210. The BIOS 1204 includes a set of software instructions that, when executed by the processing unit 1184, cause the computing device 1180 to boot up. The operating system 1206 includes a set of software instructions that, when executed by the processing unit 1184, cause the computing device 1180 to provide an operating system that coordinates the activities and resources of the computing device 1180. Example types of operating systems include, but are not limited to, Microsoft Windows, Linux, Unix, Apple OS X, Apple iOS, Palm webOS, Palm OS, Google Chrome OS, Google Android OS, and so on. The application software 1208 includes a set of software instructions that, when executed by the processing unit 1184, cause the computing device 1180 to provide applications to a user of the computing device 1180. The program data 1210 is data that the application software 1208 generates or uses or both.

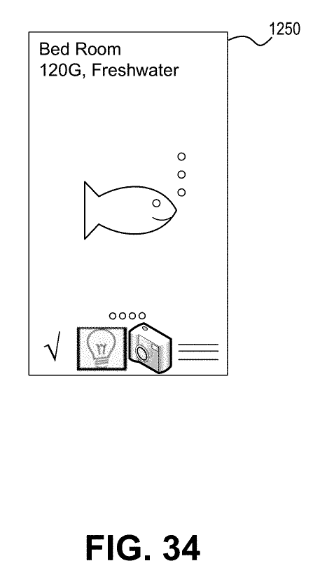

Referring now to FIG. 34, another example user interface screen 1250 for displaying information about the habitat device 108 is illustrated. The user interface screen 1250 is generated by some embodiments of the user interface engine 394 and is displayed by some embodiments of the user computing device 104. In some embodiments, the user interface screen 1250 may operate as a home screen that may be displayed after the application starts up or after a particular habitat device has been selected. Further, in some embodiments, the background of the user interface screen 1250 may include image or video captured by the camera functional device 118. In other embodiments, the background of the user interface screen 1250 includes an image selected by the user U.

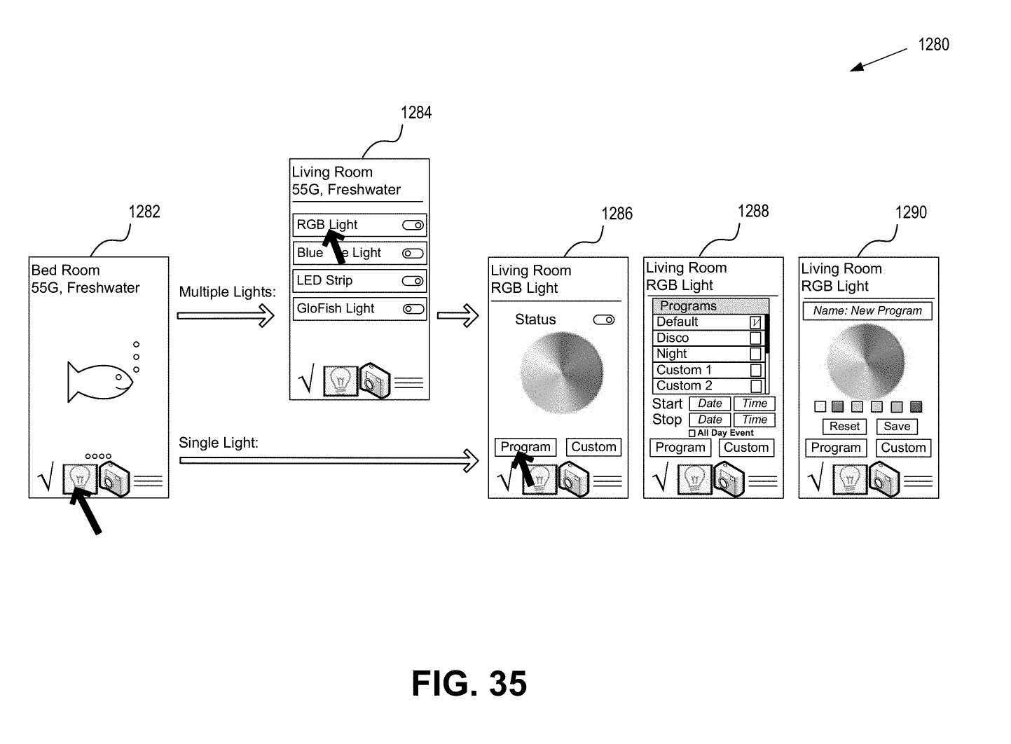

Referring now to FIG. 35, an example user interface flow 1280 for controlling one or more light functional device 112 is shown. The user interface flow 1280 is generated by some embodiments of the user interface engine 394 and displayed by some embodiments of the user computing device for controlling one or more lighting functional device of FIG. 1.

The flow 1280 starts with user interface screen 1282, which may be similar to the user interface screen 1250 (which is illustrated and described with respect to at least FIG. 34).

Upon receiving a user selection of the lighting option from the navigation menu on the user interface screen 1282, the flow 1280 proceeds to either user interface screen 1284 (if there are multiple light functional devices associated with the habitat) or user interface screen 1286 (if there is only one light functional device). At user interface screen 1284, the user U may enable/disable various light functional devices and select a particular light functional device.

Upon receiving a selection of a particular light functional device, the flow 1280 continues to the user interface screen 1286, which may be similar to the user interface screen 870 (which is illustrated and described with respect to at least FIG. 24). In addition, the user interface screen 1286 includes a program button and a custom button.

Upon receiving an indication that a user actuated the program button, the flow 1280 continues to the user interface screen 1288. The user interface screen 1288 displays a list of available lighting programs, which the user U may select and activate or deactivate.

Upon receiving an indication that a user actuated the custom button (on either the user interface screen 1286 or the user interface screen 1288), the flow 1280 continues to the user interface screen 1290. The user interface screen 1290 displays user interface elements that a user can use to define a custom lighting program. Upon completing the custom lighting program, the user may save the custom lighting program for later use or further editing.

The various embodiments described above are provided by way of illustration only and should not be construed to limit the claims attached hereto.

Those skilled in the art will readily recognize various modifications and changes that may be made without following the example embodiments and applications illustrated and described herein, and without departing from the true spirit and scope of the following claims.

What is claimed is:

1. A habitat control system comprising:
a habitat functional device configured to perform a function within a habitat, wherein the habitat functional device stores identification data; and
a habitat control hub configured to provide power to the habitat functional device and to transmit instructions to the habitat functional device.

2. The habitat control system of claim 1, wherein the habitat control hub includes a switchless power delivery device and provides continuous power to the habitat functional device.

3. The habitat control system of any of claims 1 to 2, further comprising:
a cable that forms an electrical path between the habitat functional device and the habitat control hub.

4. The habitat control system of claim 3, wherein the cable is a USB cable.

5. The habitat control system of any of claims 3 to 4, wherein the cable comprises four wires, wherein at least two of the four wires are arranged to form a twisted pair.

6. The habitat control system of any of claims 3 to 5, wherein the cable comprises a first connector configured to connect to the habitat functional device and a second connector configured to connect to the habitat control hub.

7. The habitat control system of any of claims 3 to 5, wherein the cable is integral with the habitat functional device.

8. The habitat control system of any of claims 3 to 7, wherein the habitat functional device is configured to provide continuous power to the habitat functional device via the cable and to transmit instructions to habitat functional device via the cable.

9. The habitat control system of any of claims 1 to 8, wherein the habitat functional device is configured to transmit the identification data to the habitat control hub.

10. The habitat control system of any of claims 1 to 9, further comprising a user computing device having a habitat control engine, wherein the habitat control engine is configured to:
receive, from the habitat control hub, identification data sent by the habitat functional device; and
determine an instruction format for the habitat functional device based on the identification data.

11. The habitat control system of any of claims 1 to 10, wherein the habitat functional device is configured to:
receive an activate instruction; and
in response to receiving the activate instruction, perform a function in a habitat.

12. The habitat control system of any of claims 1 to 11, further comprising a server computer device, wherein the server computing device is configured to transmit instructions to the habitat control hub and the habitat control hub is configured to receive instructions from the server computing device and transmit the received instructions to the habit functional device.

13. The habitat control system of any of claims 1 to 12, wherein the habitat functional device comprises a light functional device and is configured to receive an instruction to select a mode for light emission.

14. The habitat control system of any of claims 1 to 13, wherein the habitat control hub is configured to transmit an instruction to the light functional device to emit light that is synchronized to music.

15. The habitat control system of any of claims 1 to 14, further comprising:
a temperature functional device; and
a camera functional device.

16. The habitat control system of any of claims 1 to 15, further comprising the habitat.

17. The habitat control system of any of claims 1 to 16, wherein the habitat comprises an aquarium.

18. The habitat control system of any of claims 1 to 16, wherein the habitat comprises a terrarium.

19. A habitat control hub comprising:
a connectivity port configured to connect to a habitat functional device;
a network interface device configured to communicate over a network;
a power delivery device configured to transmit power to the habitat functional device via the connectivity port; and
a control unit.

20. The habitat control hub of claim 19, where the control unit comprises:
a server interface engine configures to communicate with a server computing device via the network interface device; and
a habitat functional device interface engine configured to communicate with the habitat functional device via the connectivity port.

21. The habitat control hub of claim 20, wherein the server interface engine is configured to receive instructions from the server computing device and wherein the habitat functional device interface engine is configured to transmit a corresponding instruction to the habitat functional device.

22. The habitat control hub of any of claims 19 to 20, wherein the network interface device is configured to connect to the network using Wi-Fi.

23. A habitat functional device comprising:
a function performing device configured to perform a function within a habitat;
a power receiving device configured to receive power from a habitat control hub;
an identification engine configured to transmit identification information to the habitat control hub; and
a habitat interface engine configured to receive instructions from the habitat control hub.

24. The habitat functional device of claim 23, wherein the identification information comprises a device type and a serial number.

25. The habitat functional device of claim 23, further comprising:
a tactile input control device connected to the function performing device, wherein the tactile input control device is configured to selectively control the operation of the function performing device; and
wherein, the habitat interface engine is configured to selectively operate in a connected mode and when operating in the connected mode, the habitat interface engine disables operation of the tactile input control device.

26. A method for controlling a habitat functional device, the method comprising:
transmitting, from a user computing device, account identification information associated with a user account to a server computing device;
receiving, from the server computing device, information about a habitat device associated with the user account, wherein the information includes a list of habitat functional devices associated with the habitat device; and
transmitting an instruction for a habitat functional device from the list of habitat functional devices to the server computing device.

27. The method of claim 26, further comprising receiving, on the computing device, login information for the user account from a user, and wherein transmitting account identification information associated with the user account to the server computing device comprises using the login information to login to the user account on the server computing device.

28. The method of any of claims 26 to 27, wherein the list of habitat functional devices includes one habitat functional device.

29. The method of any of claims 26 to 27, wherein the list of habitat functional devices includes multiple habitat functional devices.

30. A method for controlling a habitat functional device, the method comprising:
transmitting an information request to a habitat control hub from a user computing device;
receiving, from the habitat control hub, a list of habitat functional devices connected to the habitat device; and
transmitting to the habitat control hub an instruction for a habitat functional device from the list of habitat functional devices.

31. The method of claim 30, further comprising:
pairing with the habitat control hub using Bluetooth.

32. The method of claim 30, further comprising:
connecting to a local area network wirelessly through a wireless access point;
identifying a habitat control hub on the local area network.

33. The method of claim 32, further comprising:
authenticating with the habitat control hub.

34. The method of claim 30, further comprising:
receiving, on the user computing device, login information from a user;
using the login information to login to a user account on a server computing device;
receiving, from the server computing device, information about a habitat device associated with the user account.

35. The method of claim 34, wherein:
transmitting an information request to a habitat control hub from a user computing device comprises transmitting the information request to the server computing device;
receiving, from the habitat control hub, a list of habitat functional devices connected to the habitat device comprises receiving the list from the server computing device; and
transmitting to the habitat control hub an instruction for a habitat functional device from the list of habitat functional devices comprises transmitting the instruction to the server computing device.

36. An aquarium connectivity system, the system comprising:
a habitat functional device configured to perform a function within an aquarium, wherein the habitat functional device stores identification data; and
a habitat control hub configured to provide power to the habitat functional device and to transmit instructions to the habitat functional device.

37. A terrarium connectivity system, the system comprising:
a habitat functional device configured to perform a function within a terrarium, wherein the habitat functional device stores identification data; and
a habitat control hub configured to provide power to the habitat functional device and to transmit instructions to the habitat functional device.

38. A pond connectivity system comprising:
a habitat functional device configured to perform a function within a pond, wherein the habitat functional device stores identification data; and
a habitat control hub configured to provide power to the habitat functional device and to transmit instructions to the habitat functional device.

39. A method of managing an environment in a habitat device, comprising:
receiving, on a computing device, login information from a user;
using the login information to login to a user account on a server computing device;
receiving, from the server computing device, information about a habitat device associated with the user;
accessing an image associated with the habitat device;
evaluating an environmental property associated with the habitat device based in part on the image; and
generating a recommendation based on the evaluated environmental property.

40. The method of claim 39, wherein the image is captured by the computing device.

41. The method of any of claims 39 to 40, wherein the image includes a test strip.

42. The method of any of claims 39 to 41, further comprising:
receiving information about products the user has added to inventory.

43. The method of claim 42, wherein the recommendation is generated at least in part based on the products the user has added to inventory.
